(19) United States
(12) Patent Application Publication
(10) Pub. No.: US 2016/0239171 A1
(43) Pub. Date: Aug. 18, 2016

(54) INFORMATION DISPLAY APPARATUS, DISTRIBUTION APPARATUS, INFORMATION DISPLAY METHOD, AND NON-TRANSITORY COMPUTER READABLE STORAGE MEDIUM

(71) Applicant: YAHOO JAPAN CORPORATION, Tokyo (JP)

(72) Inventors: Hiroyuki Anai, Tokyo (JP); Keisuke Kimura, Tokyo (JP); Daisuke Kobayashi, Tokyo (JP)

(73) Assignee: YAHOO JAPAN CORPORATION, Tokyo (JP)

(21) Appl. No.: 14/991,320

(22) Filed: Jan. 8, 2016

(30) Foreign Application Priority Data
Feb. 16, 2015 (JP) 2015-028098

(51) Int. Cl. G06F 3/0485; G06F 17/22; G06T 3/40

(52) U.S. Cl. CPC G06F 3/0485; G06T 3/40; G06F 17/2247

(57) ABSTRACT

An information display apparatus includes a display unit that displays a first content and a second content different from the first content. The information display apparatus includes a control unit that, when a moving operation is performed on the first content, reduces a display area of the second content in a direction in which the moving operation is performed, without moving the second content, to thereby expand an area in which the first content is displayed.

### CROSS-REFERENCE TO RELATED APPLICATIONS

The present application claims priority to and incorporates by reference the entire contents of Japanese Patent Application No. 2015-028098 filed in Japan on Feb. 16, 2015.

### BACKGROUND OF THE INVENTION

1. Field of the Invention

The present invention relates to an information display apparatus, a distribution apparatus, an information display method, and a non-transitory computer readable storage medium.

2. Description of the Related Art

Conventionally, there is a known technology for displaying various kinds of information on arbitrary information display apparatuses including smart devices such as smartphones or tablet personal computers (PCs), desktop PCs, and the like. As an example of the technology, there is a known technology for attracting interest in a predetermined content by displaying the content on a screen and changing display modes of the content in accordance with an operation performed by a user. For example, there is a known technology for displaying a web page and a content related to advertisement on a screen, and expanding an area for displaying the content when a user performs a scroll operation on the web page.
Patent Document 1: Japanese Laid-open Patent Publication No. 2014-049095.

However, in the conventional technology as described above, in some cases, an appeal effect of information related to the content is not always high. For example, in the conventional technology, because the area for displaying the content is increased when a scroll operation is performed on the web page, the impression that a user who pays close attention to the web page gets from the content may be negative.

### SUMMARY OF THE INVENTION

It is an object of the present invention to at least partially solve the problems in the conventional technology.

According to one aspect of an embodiment, an information display apparatus includes a display unit that displays a first content and a second content different from the first content. The information display apparatus includes a control unit that, when a moving operation is performed on the first content, reduces a display area of the second content in a direction in which the moving operation is performed, without moving the second content, to thereby expand an area in which the first content is displayed.

According to the other aspect of an embodiment, a distribution apparatus includes a distribution unit that distributes control information to a terminal device that displays a first content and a second content different from the first content. The control information causes the terminal device to display the first content and the second content. The control information causes the terminal device to reduce, when a moving operation is performed on the first content, a display area of the second content without moving the second content, to thereby expand an area in which the first content is displayed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a terminal device according to an embodiment;

FIG. 2 is a diagram illustrating a configuration example of a distribution system according to the embodiment;

FIG. 3 is a diagram illustrating a configuration example of an advertisement distribution server according to the embodiment;

FIG. 4 is a diagram illustrating an example of information stored in an advertisement database according to the embodiment;

FIG. 5 is a diagram illustrating a configuration example of a content distribution server according to the embodiment;

FIG. 6 is a diagram illustrating a configuration example of the terminal device according to the embodiment;

FIG. 7 is a diagram for explaining an example of setting of an arrangement area and a visible area;

FIG. 8 is a diagram illustrating a first variation of a display process performed by the terminal device according to the embodiment;

FIG. 9 is a diagram for explaining a variation of the setting of the arrangement area and the visible area;

FIG. 10 is a diagram illustrating a second variation of the display process performed by the terminal device according to the embodiment;

FIG. 11 is a flowchart illustrating an example of the flow of the display process performed by the terminal device according to the embodiment; and

FIG. 12 is a diagram illustrating an example of a hardware configuration of a computer that implements functions of the advertisement distribution server.

### DETAILED DESCRIPTION OF THE PREFERRED EMBODIMENTS

Modes (hereinafter, referred to as “embodiments”) for carrying out an information display apparatus, a distribution apparatus, an information display method, and a non-transitory computer readable storage medium according to the present invention will be described in detail below with reference to the drawings. The information display apparatus, the distribution apparatus, the information display method, and the non-transitory computer readable storage medium of the present invention are not limited by the embodiments. In each of the embodiments below, the same components will be denoted by the same reference numerals and symbols, and description thereof will be omitted.

1. Example of Terminal Device 100

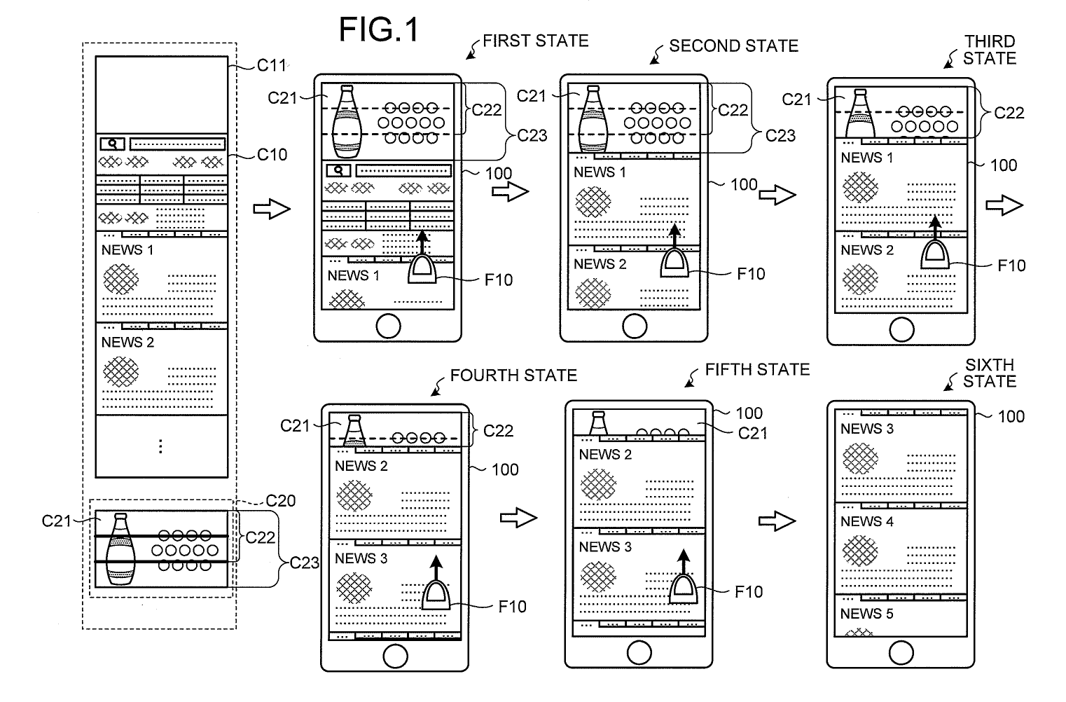

First, an example of a process performed by a terminal device 100 as an example of an information display apparatus will be described with reference to FIG. 1. FIG. 1 is a diagram illustrating an example of the terminal device according to the embodiment. FIG. 1 illustrates an example in which the terminal device 100 displays a web page C10 and a content C20.

The terminal device 100 illustrated in FIG. 1 is a smart device, such as a smartphone or a tablet, and is a mobile terminal device that can communicate with an arbitrary server device via a wireless communication network, such as third generation (3G) or a long term evolution (LTE). The terminal device 100 includes an output unit 130, such as a liquid crystal display. It is assumed that a touch panel is used in the terminal device 100. That is, a user of the terminal device 100 performs various operations by touching a display surface (hereinafter, may be described as a screen) of the output unit 130 with a finger or a stylus.

The web page C10 is a web page in which, for example, news, a weather forecast, an index or a content of received mail, a photo viewer, and various other contents are arranged, and which is described in a hyper text markup language (HTML), an extensible markup language (XML), or the like. It is assumed that, at the top of the web page C10, a space C11 with the same size as a display size of the content C20 or an arbitrary content that need not be viewed by a user is inserted.

In the following description, it is assumed that the web page C10 is a web page of a so-called portal site. It is also assumed that the web page C10 is a web page which is optimized for smart devices and whose display size in the horizontal direction is the same as a display size of the screen of the terminal device 100 in the horizontal direction. It is also assumed that the web page C10 is a web page whose display size in the vertical direction is longer than a display size of the output unit 130 of the terminal device 100 in the vertical direction and in which contents related to a plurality of news, such as “news 1” to “news 5”, are arranged.

The web page C10 may be a content in which, for example, news, a weather forecast, an index or a content of received mail, a photo viewer, and various other contents are independently arranged in tile shapes and in which an operation, an update, or the like can be performed for each of the contents arranged in the tile shapes. In this case, the size or the arrangement position of each of the tiles arranged in the web page C10 may be automatically changed for each tile or may be changed in accordance with an operation performed by a user. The web page C10 may be a web page described in an HTML, an XML, or the like. The web page C10 as described above includes an input field for inputting a search keyword, a link to a different web page, or the like.

The content C20 is a content displayed together with the web page C10, and is, for example, a content related to advertisement (hereinafter, described as an advertisement content). For example, the content C20 is a content configured with a plurality of contents C21 to C23.

More specifically, the content C21 is an image including an upper one-third of the range of an image displayed as the content C20. The content C22 is an image including upper two-thirds of the range of the image displayed as the content C20. The content C23 is an image including the entire range of the image displayed as the content C20.

The content C20 may be configured with a plurality of contents each being independent of the others, or may be configured such that a plurality of contents each being independent of the others are combined so as to provide a single different content as a whole. Furthermore, the content C20 may be configured with an arbitrary number of contents.

As will be described later, the content C20 is a content whose arrangement position and display position are set by using cascading style sheets (CSS), HTML5, or other scripts that can describe dynamic contents, and therefore whose display mode is changed in accordance with an operation performed by a user. For example, the content C20 is a content including an image, a character, a graphic, a symbol, a moving image, or the like subjected to control for display, deletion, expansion, reduction, movement, rotation, playback, pause, or the like in accordance with an operation performed by a user. The content C20 may be a web page described in an HTML, an XML, or the like, similarly to the web page C10.

It is assumed that the content related to advertisement is not only commercial and non-commercial advertisements, but also recruitment of volunteers, public service advertisements, notifications to the public, a part of information related to the web page C10, or any other arbitrary content. That is, as the content C20, not only a content including so-called advertisement related information, but also an image, a moving image, a character, a graphic, a symbol, a hyper link, or any other arbitrary content may be used as long as the content attracts interest of a user and conveys information contained in the content C20 or information contained in a content (for example, a landing page or the like) related to the content C20.

The terminal device 100, upon receiving distribution of the web page C10, transmits a distribution request to an advertisement distribution server 20 that distributes a content related to advertisement. Then, upon receiving distribution of the content C20 as the content related to advertisement from the advertisement distribution server 20, the terminal device 100 displays the web page C10 and the content C20.

2. Process Performed by the Terminal Device 100

In the conventional technology, an area for displaying a predetermined content is expanded when a scroll operation is performed on the web page C10. However, in the conventional technology, an area in which the web page C10 is displayed (hereinafter, described as a display area of the web page C10) is reduced with the expansion of the area of the content. Therefore, if a user pays close attention to the web page, the impression that the user gets from the content may be negative and an appeal effect of information related to the content may not properly be achieved.

Conventionally, a display process has been performed to improve the number of impressions of the content by arranging the content within a range in which an initial display of the web page C10 is provided. However, if a user scrolls the web page C10 before distribution of the content, the number of impressions is counted based on the assumption that the content is viewed, even though the user does not actually view the content.

Furthermore, if the content is continuously displayed when the web page C10 is scrolled, the user may get a negative impression from the content. In contrast, fees for advertisement distribution are charged with respect to user's viewing, selection, or the like, and therefore, it is preferable to provide the content related to advertisement such that the content can easily attract attention of the user.

2-1. Display Process

In view of the above, the terminal device 100 performs a display process as described below. First, the terminal device 100 displays the web page C10 and the content C20. Then, if a scroll operation is performed on the web page C10, the terminal device 100 does not move the content C20 but reduces an area of the content C20 being displayed (hereinafter, described as a display area of the content C20 and the same applies to the following) in a direction in which the scroll operation is performed, to thereby expand the size of the area in which the web page C10 is displayed.

More specifically, the terminal device 100 displays the web page C10 at the upper end of the screen, and arranges and displays the content C20 in front of the web page C10. At the top of the web page C10, the space C11 with the same size as the display size of the content C20 is inserted. Therefore, the terminal device 100 displays an initial screen arranged such that the upper end of the web page C10 excluding the space C11 comes in contact with the lower end of the content C20.

The upper end of the web page C10 or the content C20 is an end that serves as a reference position when the web page C10 or the content C20 is displayed on the screen and that is arranged on the upper most side on the screen when the web page C10 or the content C20 is displayed. Furthermore, the lower end of the web page C10 or the content C20 is an end that is arranged on the lowermost side on the screen among the ends that appear when the web page C10 or the content C20 is displayed on the screen.

If a scroll operation for moving the web page C10 or the content C20 in the screen upward direction (hereinafter, described as an upward scroll operation) is performed, the terminal device 100 scrolls the web page C10 and gradually reduces the display area of the content C20 from the screen downward direction to the upward direction. The screen upward direction is a direction in which the upper end of the web page C10 or the content C20 is displayed on the screen of the terminal device 100, and the screen downward direction is a direction in which the lower end of the web page C10 or the content C20 is arranged on the screen. In other words, the terminal device 100 gradually moves the lower end of the content C20 in the screen upward direction in accordance with the scroll operation without moving the upper end of the content C20, to thereby gradually reduce the width of the display area of the content C20.

If the content C20 is configured with a plurality of the contents C21 to C23, the terminal device 100 reduces the display area of each of the contents C21 to C23 at a different timing, for each of the contents C21 to C23. For example, the terminal device 100 forms the content C20 by arranging the content C22 behind the content C21 and arranging the content C23 behind the content C22 such that the positions of the respective upper ends of the contents C21 to C23 coincide with one another.

If an upward scroll operation is performed, the terminal device 100 gradually moves the lower end of the display area of the content C23 in the screen upward direction without moving the content C23, to thereby gradually reduce the display area of the content C23 in the screen upward direction. Furthermore, after the display area of the content C23 is reduced such that the content C23 is hidden behind the content C22 and the display of the content C23 disappears, if the upward scroll operation is further performed, the terminal device 100 gradually reduces the lower end of the display area of the content C22 in the screen upward direction without moving the content C22, to thereby gradually reduce the display area of the content C22 in the screen upward direction.

Moreover, after the display area of the content C22 is reduced such that the content C22 is hidden behind the content C21 and the display of the content C22 disappears, if the upward scroll operation is further performed, the terminal device 100 gradually reduces the display area of the content C21 in the screen upward direction without moving the content C21. Consequently, the terminal device 100 gradually reduces the display area of the content C20 in accordance with the scroll operation without moving the content C20 and expands the display area of the web page C10.

The terminal device 100 may display the content C20 by arranging, as the contents C21 to C23, three equally-divided images of the content C20 next to one another, and may simultaneously reducing the respective display areas of the contents C21 to C23 so as to gradually reduce the display area of the content C20 in a slit shape.

Furthermore, the terminal device 100 sets a different timing to reduce the display area of each of the contents C21 to C23. For example, the terminal device 100 displays the display area of the content C22 without reducing the display area from when the display of the content C23 disappears to when an amount of the upward scroll operation exceeds a predetermined threshold, and starts to reduce the display area of the content C22 when the amount of the upward scroll operation exceeds the predetermined threshold.

Moreover, for example, the terminal device 100 may use different values as the amount of scroll to be performed from when the display of the entire content C23 disappears to when the display area of the content C22 starts to be reduced, and as the amount of scroll to be performed from when the display of the entire content C22 disappears to when the display area of the content C21 starts to be reduced. As described above, the terminal device 100 may reduce the size of the display area of the content C20 in an arbitrary manner as long as the terminal device 100 can gradually reduce the size of the display area of the content C20 without moving the content C20 in accordance with a scroll operation performed on the web page C10.

Furthermore, the terminal device 100 may display a predetermined landing page when a user selects the content C20. The terminal device 100 may display a different landing page for each of the contents C21 to C23, or may display a different landing page depending on the number of displayed contents among the contents C21 to C23, a ratio of an area being displayed in the content C20, or the like. Moreover, when the contents C21 to C23 are not displayed, the terminal device 100 may perform a process such that the landing page is not displayed even when a user taps the positions at which the contents C21 to C23 have been arranged.

2-2. Method to Implement Display Process

The terminal device 100 can implement the above-described display process by an arbitrary method. For example, the terminal device 100 may monitor an amount of scroll, and if the monitored amount of scroll exceeds a predetermined threshold, the terminal device 100 may gradually reduce the display area of the content C20 in accordance with the scroll operation. Furthermore, for example, the terminal device 100 determines whether a predetermined position of the web page C10 is located in the screen upward direction relative to the lower end of the content C20. If the predetermined position of the web page C10 is located in the screen upward direction relative to the lower end of the content C20, the terminal device 100 may move the lower end of the content C20 to the predetermined position in the screen upward direction.

Moreover, the terminal device 100 may implement the above-described display process by using a script, such as CSS. For example, the terminal device 100 arranges the content C20 in an arrangement area that is an area fixed at the upper end of the screen. Furthermore, the terminal device 100 sets, as a parent element of the content C20, a visible area that is an area in which the content C20 is displayed in a visible state, from the upper end of the web page C10 to a predetermined position.

If the arrangement area of the content C20 is set, the terminal device 100 attempts to arrange and display the content C20 on the arrangement area. However, if the visible area as the parent element is set, the terminal device 100 makes the content C20 visible in only the visible area. Therefore, the terminal device 100 sets a visible state in only a range of the content C20, in which the content C20 is arranged and the content C20 is visible, that is, in which the arrangement area and the visible area overlap each other, and displays the range on the screen.

For example, in the initial screen, the entire arrangement area is included in the visible area of the content C20, that is, the arrangement area and the visible area coincide with each other. Therefore, the terminal device 100 displays the entire content C20 in the initial screen. In contrast, if an upward scroll operation is performed, the visible area is moved in accordance with the scroll operation performed on the web page C10. Then, if the lower end of the content C20 is moved in the screen upward direction relative to the lower end of the arrangement area, the arrangement area and the visible area do not coincide with each other, and only a range of the content C20, in which the arrangement area and the visible area overlap each other, is displayed.

Consequently, a range of the content C20 from the lower end of the arrangement area to the lower end of the visible area is turned to an invisible state. Therefore, the terminal device 100 gradually reduces the display area of the content C20 from the lower end of the display area without moving the content C20, and displays the web page C10 arranged behind the content C20. That is, the invisible state described herein is not implemented by controlling the transparency or the like of the content C20 by a program or a script, but is implemented by not displaying a range of the arrangement area that is not included in the visible area.

The terminal device 100 may separately set the visible area and the arrangement area for each of the contents C21 to C23. For example, the terminal device 100 sets the arrangement areas of the contents C21 to C23 in sequence from the upper end of the screen, and sets the visible areas such that the lower ends are set at different positions. More specifically, the terminal device 100 sets the lower end of each of the visible areas such that gaps between the lower ends of the respective visible areas are greater than the width of the content C21 in order of the content C23, the content C22, and the content C21 from the upper end of the web page C10. Then, the terminal device 100 displays ranges of the contents C21 to C23 included in the visible areas.

If the above-described setting is performed, the terminal device 100 moves the lower end of the visible area of the content C23 in the screen upward direction relative to the lower end of the arrangement area of the content C23 through a scroll operation, to thereby gradually reduce the display area of the content C23 from the lower end and make the content C23 invisible. Furthermore, if the scroll operation is further performed, the terminal device 100 moves the lower end of the visible area of the content C22 in the screen upward direction relative to the lower end of the arrangement area of the content C22, to thereby gradually reduce the display area of the content C22 from the lower end and make the content C22 invisible. Moreover, if the scroll operation is further performed, the terminal device 100 moves the lower end of the visible area of the content C21 in the screen upward direction relative to the lower end of the arrangement area of the content C21, to thereby gradually reduce the display area of the content C21 from the lower end and make the content C21 invisible.

As described above, by setting the arrangement area of the content C20 and the visible area as the parent element of the content C20, the terminal device 100 can gradually reduce the display area of the content C20 without moving the content C20 in accordance with a scroll operation performed on the web page C10. Therefore, the terminal device 100 can easily implement the above-described display process without performing a complicated process, such as a process of determining the amount of scroll or the position of the content C10.

2-3. Direction of Scroll Operation

If a scroll operation for moving the web page C10 in the screen downward direction (hereinafter, described as a downward scroll operation) is performed, the terminal device 100 may gradually expand the display area of the content C20. For example, if the downward scroll operation is performed after the display area of the content C20 is reduced, the terminal device 100 may expand the display area of the content C20 by moving the lower end of the display area of the content C20 in the screen downward direction without moving the content C20.

2-4. Example of Process Performed by the Terminal Device 100

An example of the display process performed by the terminal device 100 will be described below with reference to FIG. 1. In the following description, an example of a display process performed by the terminal device 100 to start to reduce the display area of each of the contents C21 to C23 at a different timing in order to gradually reduce the display area of the content C20 including the contents C21 to C23 will be described in multiple parts, from a first state to a sixth state. Furthermore, in the following description, it is assumed that the lower end of the visible area of the content C23 is arranged at the position of the upper end of the “news 1” contained in the web page C10, the lower end of the visible area of the content C22 is arranged at the position of the upper end of the “news 2” contained in the web page C10, and the lower end of the visible area of the content C21 is arranged at the position of the upper end of the “news 3” contained in the web page C10.

First, the terminal device 100 accepts distribution of the web page C10 and the content C20. In this case, as illustrated in the first state, the terminal device 100 arranges the contents C21 to C23 next to one another from the upper end of the screen, and arranges and displays the web page C10 from the upper end of the screen, to thereby display an initial screen in which the web page C10 and the content C20 are arranged next to each other.

If a user performs an upward scroll operation on the web page C10 with a finger F10, the terminal device 100 scrolls the web page C10 in the screen upward direction. If the upper end of the “news 1” contained in the web page C10 is moved in the screen upward direction relative to the lower end of the content C23, that is, if the upper end of the visible area of the content C23 is moved in the screen upward direction relative to the lower end of the arrangement area of the content C23, the terminal device 100 starts to reduce the display area of the content C23 in accordance with the position of the upper end of the “news 1” as illustrated in the second state.

The terminal device 100 gradually reduces the display area of the content C23 in accordance with the upward scroll operation and makes the content C23 invisible as illustrated in the third state. In the example illustrated in the third state, the content C23 is not entirely in the invisible state, but because a range in the visible state is arranged behind the content C22, the content C23 is not displayed on the screen and is in the invisible state.

If the upward scroll operation is further performed, the terminal device 100 does not reduce the display area of the content C22 but scrolls only the web page C10. Then, if the upper end of the “news 2” contained in the web page C10 is moved in the screen upward direction relative to the lower end of the content C22, that is, if the upper end of the visible area of the content C22 is moved in the screen upward direction relative to the lower end of the arrangement area of the content C22 as a result of the upward scroll operation, the terminal device 100 starts to reduce the display area of the content C22 in accordance with the position of the upper end of the “news 2” as illustrated in the fourth state. The terminal device 100 gradually reduces the display area of the content C22 in accordance with the upward scroll operation, makes the content C22 invisible similarly to the content C23, and displays only the content C21 as illustrated in the fifth state.

Similarly, if the upward scroll operation is further performed, the terminal device 100 does not reduce the display area of the content C21 but scrolls only the web page C10. If the upper end of the “news 3” contained in the web page C10 is moved in the screen upward direction relative to the lower end of the content C21, that is, if the upper end of the visible area of the content C21 is moved in the screen upward direction relative to the lower end of the arrangement area of the content C21 as a result of the upward scroll operation, the terminal device 100 gradually reduces the display area of the content C21 in accordance with the upward scroll operation. If the upper end of the “news 3” contained in the web page C10 is moved to the upper end of the screen, the terminal device 100 makes the content C21 invisible as illustrated in the sixth state.

If a downward scroll operation is performed, the terminal device 100 may display the content C20 by gradually expanding the display area of each of the contents C21 to C23 in order from the contents C21 to C23 as illustrated in the sixth state to the first state. Furthermore, for example, the terminal device 100 may display a button or the like to hide the content C20, and may hide the entire content C20 when the button is selected. Moreover, after hiding the entire content C20, the terminal device 100 may maintain the hidden state of the content C20 even when a downward scroll operation or the like is performed.

As described above, if the user continuously performs the upward scroll operation, the terminal device 100 gradually makes the content C20 invisible and expands the display area of the web page C10. More specifically, if a predetermined amount of a scroll operation is performed after the display area of the content C23 is reduced and the content C23 is made invisible in accordance with the scroll operation, the terminal device 100 starts a process for reducing the display area of the content C22.

Furthermore, if a predetermined amount of a scroll operation is performed after the content C22 is made invisible, the terminal device 100 starts a process for reducing the display area of the content C21. By performing the above-described process, the terminal device 100 makes the contents C21 to C23 invisible in a complicated display mode such that the display areas of the contents C21 to C23 are gradually reduced at different timings, rather than simply reducing the display areas of the contents C21 to C23 in accordance with the scroll operation.

Therefore, the terminal device 100 can prevent a user from getting a negative impression of the content C20 and can make the user aware of the content C20. Consequently, the terminal device 100 can cause the content C20 to attract attention of a user who is interested in the content C20, and can improve an appeal of information related to the content C20.

Furthermore, even if a user immediately performs an upward scroll operation from the initial screen, the terminal device 100 does not immediately make the content C20 invisible. Therefore, it is possible to ensure the first view of the content C20 while preventing the user from getting a negative impression of the content C20.

Moreover, if an upward scroll operation is performed, the terminal device 100 hides the content C20 in a complicated mode such that the terminal device 100 gradually moves the lower end of the content C20 in the upward direction without moving the content C20 in the upward direction. Therefore, the terminal device 100 can attract interest of the user in the content C20.

2-5. Execution Subject

The terminal device 100 can implement the above-described display process by using an arbitrary method, which has not been described above. For example, the terminal device 100 may implement the above-described process by downloading, in advance, an application that causes the terminal device 100 to execute the display process and by executing the application at an arbitrary timing.

Furthermore, at the same time of distribution of the web page C10 and the content C20, the terminal device 100 accepts distribution of control information for executing the above-described display process. Then, the terminal device 100 performs the above-described display process in accordance with the control information. The terminal device 100 and the like that perform the display process illustrated in FIG. 1 in accordance with the control information will be described below.

3. Configuration of Distribution System

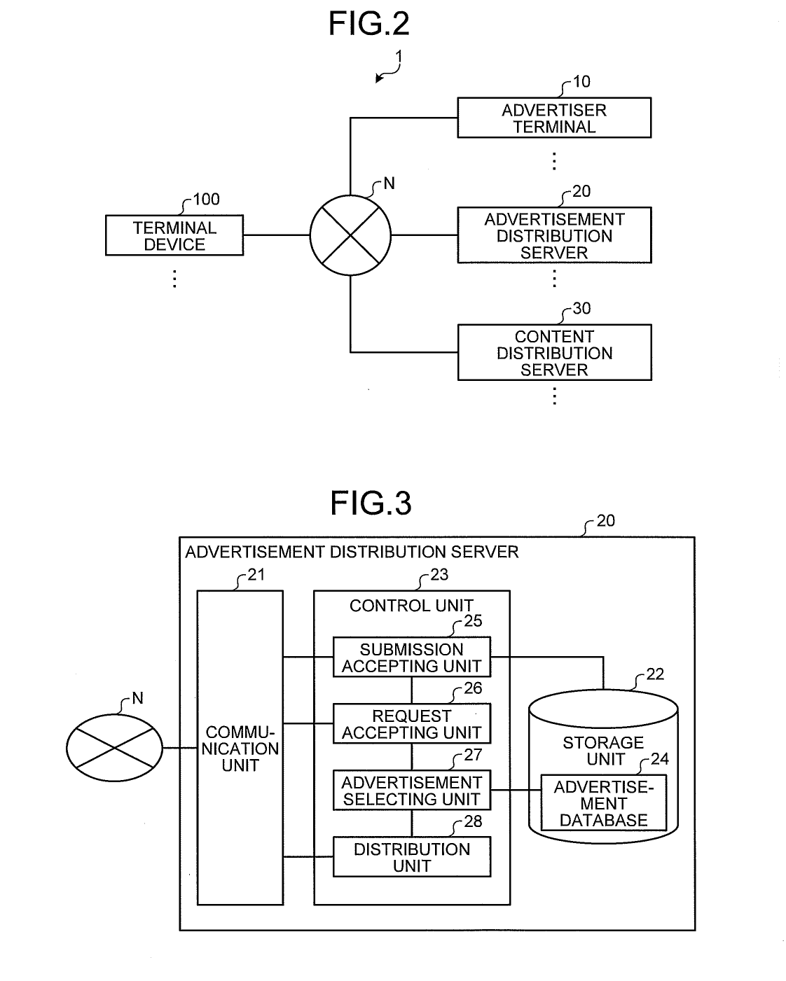

The terminal device 100 and the like that implement the above-described display process will be described below. First, a configuration of a distribution system 1 according to the embodiment will be described with reference to FIG. 2. FIG. 2 is a diagram illustrating a configuration example of the distribution system according to the embodiment. As illustrated in FIG. 2, the distribution system 1 includes the terminal device 100, an advertiser terminal 10, the advertisement distribution server 20, and a content distribution server 30. The terminal device 100, the advertiser terminal 10, the advertisement distribution server 20, and the content distribution server 30 are communicably connected to one another by wire or wireless via a network N. The distribution system 1 illustrated in FIG. 2 may include a plurality of the terminal devices 100, a plurality of the advertiser terminals 10, a plurality of the advertisement distribution servers 20, and a plurality of the content distribution servers 30.

The terminal device 100 is an information processing apparatus used by a user who views a web page. For example, the terminal device 100 is a mobile phone, such as a smartphone, a tablet terminal, a personal digital assistant (PDA), a desktop personal computer (PC), a notebook PC, or the like. The terminal device 100 acquires the web page C10 from the content distribution server 30 in accordance with an operation performed by the user, and displays the acquired web page C10. If an acquisition command to be described later is included together with the web page C10, the terminal device 100 acquires the content C20 from the advertisement distribution server 20. Furthermore, upon accepting distribution of the control information for implementing the above-described display process from the advertisement distribution server 20, the terminal device 100 operates in accordance with the control information and implements the display process.

The advertiser terminal 10 is an information processing apparatus used by an advertiser. For example, the advertiser terminal 10 is a desktop PC, a notebook PC, a tablet terminal, a mobile phone, a PDA, or the like. The advertiser terminal 10 submits an advertisement content, such as the content C20, to the advertisement distribution server 20 in accordance with an operation performed by the advertiser. For example, the advertiser terminal 10 submits, as the advertisement content, the content C20 to the advertisement distribution server 20. Furthermore, the advertiser terminal 10 submits, as the content C20, a uniform resource locator (URL) for acquiring a still image, a moving image, text data, a landing page, or the like to the advertisement distribution server 20.

In some cases, the advertiser may request an agent to submit the advertisement content. In this case, the agent submits the advertisement content to the advertisement distribution server 20. In the following, the “advertiser” is described as a concept including not only the advertiser but also the agent, and the “advertiser terminal” is described as a concept including not only the advertiser terminal 10 but also an agent terminal used by the agent.

The advertisement distribution server 20 is a server device that distributes the advertisement content submitted from the advertiser terminal 10. For example, upon accepting a distribution request for an advertisement content from the terminal device 100, the advertisement distribution server 20 performs matching between the user and an advertisement content based on a location of the terminal device 100, an attribute of the user, or the like, and distributes the advertisement content determined as a distribution target as a result of the matching. Furthermore, the advertisement distribution server 20 distributes, to the terminal device 100, the control information for implementing the above-described display process, together with the content C20 as the advertisement content. The control information is described in a script language, such as JavaScript (registered trademark) or CSS. Meanwhile, the amount of offset of the display area may be distributed as the control information, or may be distributed as information separated from the control information.

The content distribution server 30 is a web server or the like that distributes the web page C10 to the terminal device 100. For example, the content distribution server 30 distributes, to the terminal device 100, the web page C10 in which various kinds of information related to a portal site, a news site, an auction site, a weather forecast site, a shopping site, a finance (stock price) site, a route search site, a map site, a travel site, a restaurant introduction site, a weblog, and the like are arranged in tile shapes. The content distribution server 30 may be a server that distributes a web page, such as a portal site, in which various kinds of information are arranged.

The web page C10 distributed by the content distribution server 30 includes an acquisition command. For example, the URL or the like of the advertisement distribution server 20 is described, as the acquisition command, in an HTML file or the like that forms the web page C10. In this case, the terminal device 100 accesses the URL described in the HTML file or the like, and acquires the content C20 as the advertisement content from the advertisement distribution server 20.

Various kinds of data distributed from the content distribution server 30 to the terminal device 100 are, in practice, HTML files or images that form a web page, moving images displayed with the web page, or the like.

4. Configuration of Advertisement Distribution Server

A configuration of the advertisement distribution server 20 according to the embodiment will be described below with reference to FIG. 3. FIG. 3 is a diagram illustrating a configuration example of the advertisement distribution server according to the embodiment. As illustrated in FIG. 3, the advertisement distribution server 20 includes a communication unit 21, a storage unit 22, and a control unit 23.

The communication unit 21 is implemented by, for example, a network interface card (NIC) or the like. The communication unit 21 is connected to the network N by wire or wireless, and performs transmission and reception of information with the terminal device 100, the advertiser terminal 10, and the content distribution server 30.

The storage unit 22 is implemented by, for example, a semiconductor memory device, such as a random access memory (RAM) or a flash memory, or a storage device, such as a hard disk or an optical disk. The storage unit 22 stores therein an advertisement database 24 as a database for storing various kinds of information related to an advertisement content submitted from the advertiser terminal 10.

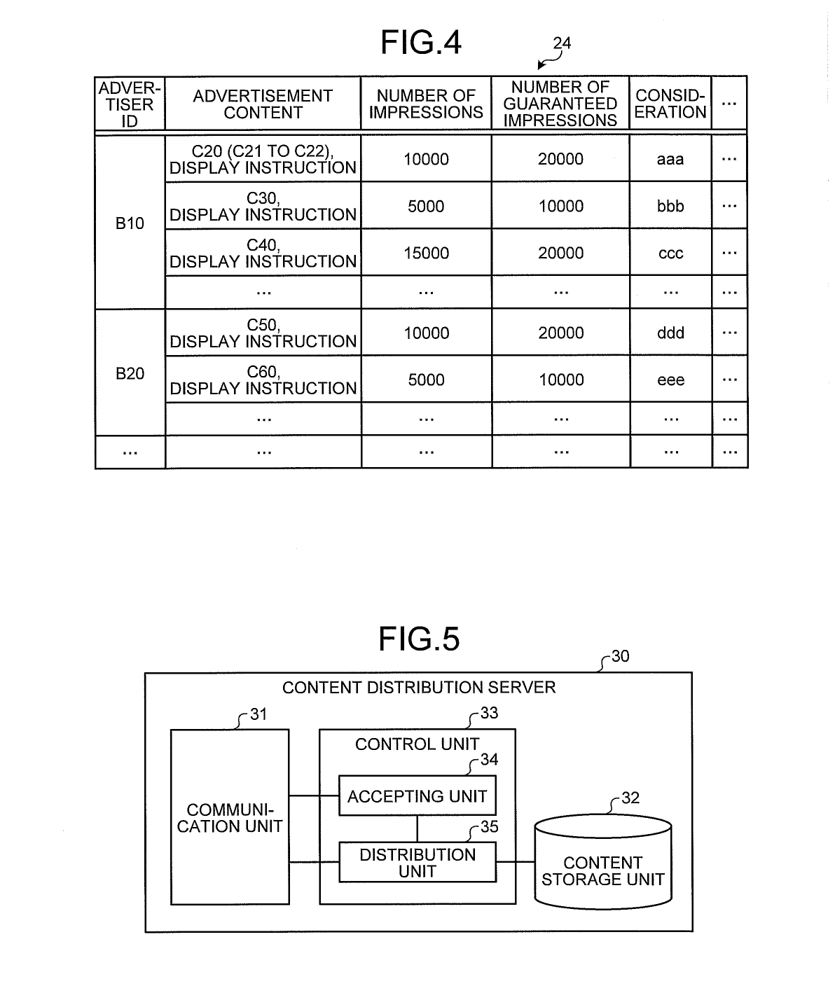

FIG. 4 is a diagram illustrating an example of information stored in the advertisement database according to the embodiment. In the example illustrated in FIG. 4, the advertisement database 24 contains items of an advertiser ID, an advertisement content, the number of impressions, the number of guaranteed impressions, and a consideration. The advertisement database 24 may further store therein information for performing matching between a content and a user, or information such as a click through rate (CTR).

The “advertiser ID” is identification information for identifying an advertiser or the advertiser terminal 10. The “advertisement content” is a content submitted from the advertiser terminal 10, that is, a content, such as the content C20, related to advertisement. In FIG. 4, an example is illustrated in which conceptual information, such as “C20” to “C60”, is stored in the “advertisement content”. However, in practice, a URL as a location of each of contents, such as an individual image, a moving image, audio and video, text data, game data, and an advertisement in a game format for conveying common information to a user, a file path name indicating a storage location of each of the contents, or the like is stored.

In the advertisement database 24, a display instruction to instruct a change in the display mode of the content C20 is registered as the advertisement content, in addition to the content C20. The display instruction includes setting values of the visible areas and the arrangement areas of the contents C21 to C23 included in the content C20.

For example, in the advertisement database 24, the number of pixels, such as “0 to 1000 pixels” or “300 to 1000 pixels”, indicating a range of the visible area with reference to the upper end of the web page C10 is registered for each of the contents C21 to C23. Furthermore, in the advertisement database 24, the number of pixels, such as “0 to 100 pixels” or “100 to 200 pixels”, indicating a range of the arrangement area with reference to the upper end of the screen is registered for each of the contents C21 to C23. The terminal device 100 can change the display mode of the content C20 in an arbitrary manner by a combination of the setting of the visible area and the setting of the arrangement area.

The display instruction includes information indicating an operation performed by a user, a status of the terminal device 100, or the like to be a trigger for transition to a landing page of the content C20. For example, an advertiser performs arbitrary setting for the above-described display instruction when the advertiser registers an advertisement content.

The “number of impressions” indicates the number of times the advertisement content is displayed. The “number of guaranteed impressions” indicates the number of displays of an advertisement content guaranteed with respect to a consideration. The “consideration” indicates a compensation to be paid by the advertiser when the advertisement content is displayed by the “number of guaranteed impressions”. That is, the advertisement distribution server 20 is a server that distributes a content related to advertisement in an impression-guaranteed form.

Specifically, FIG. 4 illustrates an example in which an advertiser identified by an advertiser ID “B10” submits the content C20 as the advertisement content. Furthermore, FIG. 4 illustrates an example in which the number of impressions of the advertisement content “C20” is “10000”, the number of guaranteed impressions is “20000”, and an amount of fees for displays of the content “C20” by the number of guaranteed impressions is “aaa”. The advertisement distribution server 20 may count the number of impressions for each of the contents C21 to C23.

When the content related to advertisement is distributed in a pay-per-click form in which a fee is charged every time the advertisement content is selected, the number of selections of the content, an amount of fees to be charged upon selection of the content, and the like are registered in the advertisement database 24. Furthermore, when an advertisement content is selected in a bidding form and the selected advertisement content is distributed upon reception of a distribution request, a bid price as an advertisement fee that is set by the advertiser as a compensation per impression, a CTR, or the like is registered in the advertisement database 24.

Referring back to FIG. 3, the description is continued. The control unit 23 is implemented by, for example, executing various programs stored in an internal storage device of the advertisement distribution server 20 by a central processing unit (CPU), a micro processing unit (MPU), or the like using a RAM as a work area. Furthermore, the control unit 23 is implemented by, for example, an integrated circuit, such as an application specific integrated circuit (ASIC) or a field programmable gate array (FPGA).

As illustrated in FIG. 3, the control unit 23 includes a submission accepting unit 25, a request accepting unit 26, an advertisement selecting unit 27, and a distribution unit 28, and implements or executes functions and operations of information processing as described below. The internal configuration of the control unit 23 is not limited to the configuration illustrated in FIG. 3, and any other configuration that performs the information processing as described below is applicable. Furthermore, a connection relation between processing units of the control unit 23 is not limited to the connection relation illustrated in FIG. 3, and any other connection relation is applicable.

The submission accepting unit 25 accepts submission of an advertisement content from the advertiser terminal 10. Specifically, the submission accepting unit 25 accepts submission of an advertisement content together with designation of a consideration. Furthermore, the submission accepting unit 25 accepts the content C20 and a display instruction. In this case, the submission accepting unit 25 registers the content C20 and the display instruction in the advertisement database 24 together with the advertiser ID and a value of the accepted consideration.

The request accepting unit 26 accepts an acquisition request for an advertisement content from the terminal device 100. For example, the request accepting unit 26 accepts an HTTP request as the acquisition request for the advertisement content.

When the request accepting unit 26 accepts the acquisition request for the advertisement content, the advertisement selecting unit 27 selects an advertisement content as a distribution candidate from the advertisement database 24. For example, the advertisement selecting unit 27 performs matching of an advertisement content to be a distribution target among advertisement contents registered in the advertisement database 24, on the basis of a location of the terminal device 100 or an attribute of the user. In the matching, the advertisement content is selected such that the number of impressions is greater than the number of guaranteed impressions. For example, the advertisement selecting unit 27 preferentially selects an advertisement content for which a difference between the number of guaranteed impressions and the number of impressions is the greatest. The advertisement selecting unit 27 may preferentially select an advertisement content with a high bid price or a high CTR, or an advertisement content with a high bid price and a high CTR. The advertisement selecting unit 27 outputs the advertisement content selected as the distribution target to the distribution unit 28.

If a web page is a search page, the advertisement selecting unit 27 may use an advertisement distribution method called search advertising to extract an advertisement content that matches a search keyword specified in a search page. Furthermore, the advertisement selecting unit 27 may use an advertisement distribution method called targeted distribution to extract an advertisement content that matches attribute information (a psychographic attribute, a demographic attribute, or the like) of the user.

The distribution unit 28 distributes the control information to the terminal device 100 together with the advertisement content selected by the advertisement selecting unit 27. Specifically, upon receiving the advertisement content selected by the advertisement selecting unit 27, the distribution unit 28 extracts a display instruction contained in the received advertisement content. The distribution unit 28 generates control information for causing the terminal device 100 to perform a display process indicated by the extracted display instruction. The control information includes, for example, information indicating the positions of the visible area and the arrangement area of each of the contents C21 to C23. Subsequently, the distribution unit 28 distributes the generated control information and the advertisement content to the terminal device 100.

5. Configuration of Content Distribution Server

A configuration of the content distribution server 30 according to the embodiment will be described below with reference to FIG. 5. FIG. 5 is a diagram illustrating a configuration example of the content distribution server according to the embodiment. As illustrated in FIG. 5, the content distribution server 30 includes a communication unit 31, a content storage unit 32, and a control unit 33.

The communication unit 31 is implemented by, for example, a NIC or the like. The communication unit 31 is connected to the network N by wire or wireless, and performs transmission and reception of information with the terminal device 100 and the advertisement distribution server 20.

The content storage unit 32 is implemented by, for example, a semiconductor memory device, such as a RAM or a flash memory, or a storage device, such as a hard disk or an optical disk. The content storage unit 32 stores therein a web page as an example of the content. For example, the content storage unit 32 stores therein an HTML file that forms a web page, or a still image or a moving image displayed on a web page.

The control unit 33 is implemented by, for example, executing various programs (corresponding to an example of a distribution program) stored in an internal storage device of the content distribution server 30 by a CPU, an MPU, or the like using a RAM as a work area. Furthermore, the control unit 33 is implemented by, for example, an integrated circuit, such as an ASIC or an FPGA.

As illustrated in FIG. 5, the control unit 33 includes an accepting unit 34 and a distribution unit 35, and implements or executes functions and operations of information processing as described below. The internal configuration of the control unit 33 is not limited to the configuration illustrated in FIG. 5, and any other configuration that performs the information processing as described below is applicable. Furthermore, a connection relation between processing units of the control unit 33 is not limited to the connection relation illustrated in FIG. 5, and any other connection relation is applicable.

The accepting unit 34 accepts an acquisition request for a web page from the terminal device 100. For example, the accepting unit 34 accepts an HTTP request as the acquisition request for a web page.

When the accepting unit 34 accepts the acquisition request for a web page, the distribution unit 35 distributes the web page to the terminal device 100. Specifically, the distribution unit 35 acquires a web page as a target of the acquisition request from the content storage unit 32, and distributes the acquired web page to the terminal device 100.

Furthermore, the distribution unit 35 generates the web page C10 and distributes the generated web page C10 to the terminal device 100. In this case, upon receiving the web page C10, the terminal device 100 transmits an advertisement distribution request to the advertisement distribution server 20 and displays an advertisement content received as a response. Then, the terminal device 100 performs a display process for changing the advertisement content in accordance with an operation performed by the user.

6. Configuration of Terminal Device

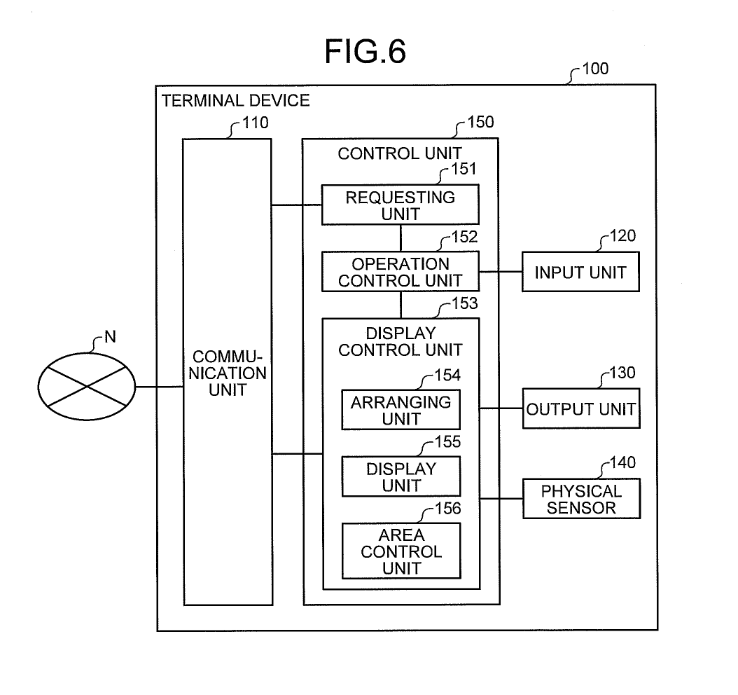

A configuration of the terminal device 100 according to the embodiment will be described below with reference to FIG. 6. FIG. 6 is a diagram illustrating a configuration example of the terminal device according to the embodiment. As illustrated in FIG. 6, the terminal device 100 includes a communication unit 110, an input unit 120, the output unit 130, a physical sensor 140, and a control unit 150.

The communication unit 110 is implemented by, for example, a NIC or the like. The communication unit 110 is connected to the network N by wire or wireless, and performs transmission and reception of information with the advertisement distribution server 20 and the content distribution server 30.

The input unit 120 is an input device that accepts various operations from a user. For example, the input unit 120 is implemented by a keyboard, a mouse, an operation key, or the like. The output unit 130 is a display device that displays various kinds of information. For example, the output unit 130 is implemented by a liquid crystal display or the like. If a touch panel is used in the terminal device 100, the input unit 120 and the output unit 130 are integrated with each other. In the following description, the output unit 130 may be described as a screen.

The physical sensor 140 is a sensor that detects a physical state of the terminal device 100. For example, the physical sensor 140 is a gyro sensor that measures inclinations of the terminal device 100 in three axial directions. The physical sensor 140 is not limited to the gyro sensor, but an arbitrary sensor, such as an acceleration sensor, a temperature sensor, a volume sensor, or a brightness sensor, is applicable.

The control unit 150 is implemented by, for example, executing various programs (corresponding to an example of a display program) stored in an internal storage device of the terminal device 100 by a CPU, an MPU, or the like using a RAM as a work area. For example, the various programs correspond to an application program called a web browser. Furthermore, the control unit 150 is implemented by, for example, an integrated circuit, such as an ASIC or an FPGA.

As illustrated in FIG. 6, the control unit 150 includes a requesting unit 151, an operation control unit 152, and a display control unit 153, and implements or executes functions and operations of information processing as described below. The internal configuration of the control unit 150 is not limited to the configuration illustrated in FIG. 6, and any other configuration that performs the information processing as described below is applicable. Furthermore, a connection relation between processing units of the control unit 150 is not limited to the connection relation illustrated in FIG. 6, and any other connection relation is applicable.

The requesting unit 151, upon receiving the URL of the web page C10 from the operation control unit 152, transmits an acquisition request for the web page C10 indicated by the received URL to the content distribution server 30. Furthermore, if the web page C10 received from the content distribution server 30 includes an acquisition command, the requesting unit 151 transmits an acquisition request for the advertisement content to the advertisement distribution server 20.

The operation control unit 152 performs various kinds of control in accordance with a user's operation accepted via the input unit 120. For example, if the user performs an operation of displaying the web page C10 through the input unit 120, the operation control unit 152 outputs the URL of the web page C10 as a display target to the requesting unit 151. Furthermore, the operation control unit 152 outputs the contents of the user's operation, such as a scroll operation or a tap operation, accepted through the input unit 120 to the display control unit 153.

The display control unit 153 performs a process of displaying the received web page and the received advertisement content on the output unit 130. For example, when the control unit 150 executes the control information distributed together with the advertisement content, the display control unit 153 operates as an arranging unit 154, a display unit 155, and an area control unit 156 as illustrated in FIG. 6 and performs the display process. The arranging unit 154, the display unit 155, and the area control unit 156 are implemented by, for example, executing the control information by the CPU, the MPU, or the like using the RAM as a work area.

The arranging unit 154 arranges the contents C21 to C23 next to one another. For example, upon receiving a plurality of the contents C21 to C23 as the content C20, the arranging unit 154 arranges each of the contents C21 to C23 in the arrangement area of each of the contents C21 to C23 such that the contents C21 to C23 are displayed as the content C20. Furthermore, the arranging unit 154 arranges the web page C10 behind each of the contents C21 to C23.

The display unit 155 displays the web page C10 and the content C20. Specifically, the display unit 155 displays the contents C21 to C23 and the web page C10 arranged by the arranging unit 154. Furthermore, the display unit 155 scrolls the web page C10 in accordance with a scroll operation. Then, the display unit 155 displays only a range of each of the contents C21 to C23 included in the corresponding visible area.

The area control unit 156 moves the visible area of each of the contents C21 to C23 in accordance with the scroll operation performed on the web page C10, to thereby reduce the display area of each of the contents C21 to C23 in a direction in which the scroll operation is performed, without moving each of the contents C21 to C23. Consequently, the area control unit 156 expands the size of the display area of the web page C10.

More specifically, the area control unit 156 moves the visible area set for each of the contents C21 to C23 in accordance with a scroll operation, similarly to the web page C10. Therefore, the area control unit 156 gradually and separately reduces the display area of each of the contents C21 to C23 from the screen downward direction to the upward direction in accordance with a scroll operation in the upward direction.

Incidentally, the respective lower ends of the visible areas C21b to C23b of the contents C21 to C23 are set at different positions. Therefore, by moving each of the visible areas, the area control unit 156 reduces the display area of each of the contents C21 to C23 at a different timing. Furthermore, the lower end of the visible area of each of the contents C21 to C23 are set in order of the content C23, the content C22, and the content C21 with reference to the upper end of the web page C10. Therefore, the area control unit 156 starts to reduce the display area of each of the contents C21 to C23 in order of the content C23, the content C22, and the content C21.

Furthermore, if a space is provided between the lower end of the visible area C23b and the lower end of the visible area C22b and between the lower end of the visible area C22b and the lower end of the visible area C21b, the terminal device 100 performs a display process as described below. Specifically, even if a scroll operation is performed after the content C23 is made invisible, the terminal device 100 does not reduce the display area of the content C22 for a while, and starts a process of reducing the display area of the content C22 after a predetermined amount of the scroll operation is performed. Moreover, even if a scroll operation is performed after the content C22 is made invisible, the terminal device 100 does not reduce the display area of the content C21 for a while, and starts a process of reducing the display area of the content C21 after a predetermined amount of the scroll operation is performed.

As described above, the terminal device 100 gradually reduces the display areas of the contents C21 to C23 at different timings. Therefore, for example, when displaying a content or the like whose display size in the vertical direction is long, the terminal device 100 displays the entire content and gradually reduces the display area in accordance with a scroll operation. Consequently, it is possible to prevent a user from getting a negative impression of the content and improve the appeal effect of the information related to the content.

7. Example of Setting of Arrangement Area and Visible Area

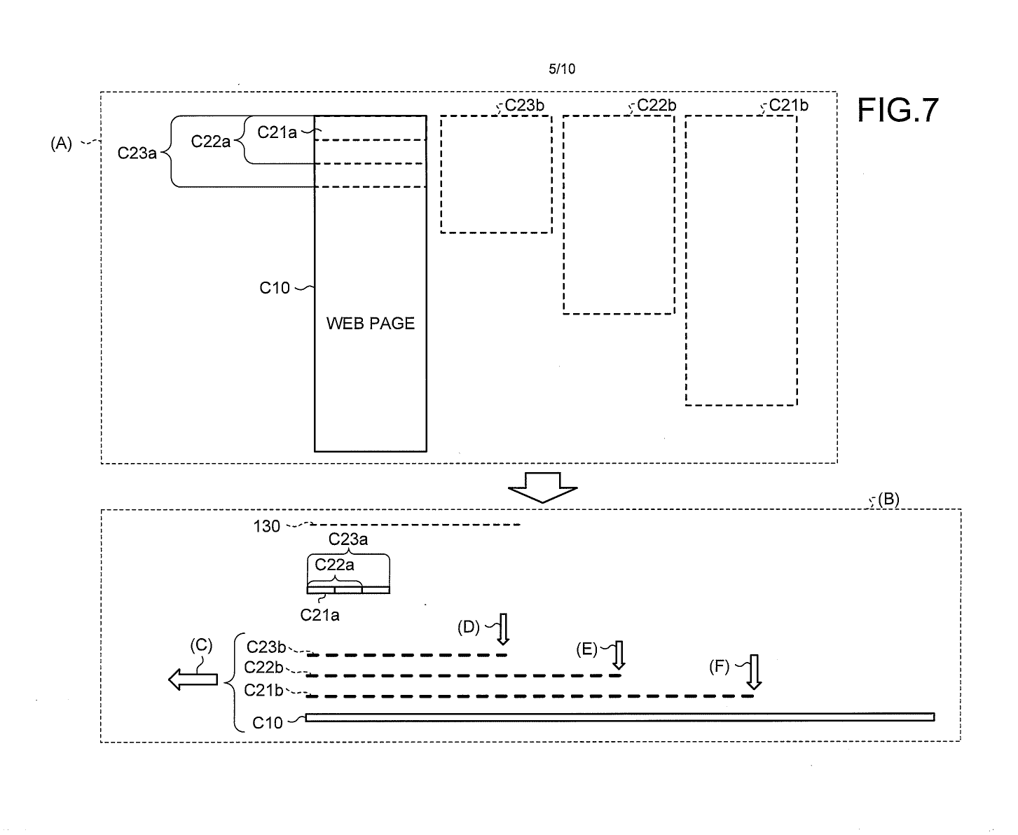

FIG. 7 is a diagram for explaining an example of setting of the arrangement area and the visible area. For example, in the example illustrated in (A) in FIG. 7, the arrangement area C21a of the content C21, the arrangement area C22a of the content C22, and the arrangement area C23a of the content C23 are set from the upper end of the web page C10. Furthermore, in the example illustrated in (A) in FIG. 7, the visible area C23b of the content C23 is set from the upper end of the web page, the visible area C22b of the content C22 is set such that a distance to the lower end is longer than that of the visible area C23b, and the visible area C21b of the content C21 is set such that a distance to the lower end is longer than that of the visible area C22b.

In this case, as illustrated in (B) in FIG. 7, the terminal device 100 arranges each of the contents C21 to C23 at the upper end of the screen of the output unit 130 and arranges the web page C10 behind the contents C21 to C23. In the example illustrated in (B) in FIG. 7, dotted lines schematically representing the visible areas C21b to C23b are arranged between the contents C21 to C23 and the web page C10. As indicated by (C) in FIG. 7, the terminal device 100 moves the web page C10 and each of the visible areas C21b to C23 in accordance with a scroll operation.

The lower end of the visible area C22b is set in the screen downward direction relative to the lower end of the visible area C23b, and the lower end of the visible area C21b is set in the screen downward direction relative to the lower end of the visible area C21b. Therefore, the terminal device 100 moves the lower end of the visible area C23b indicated by (D) in FIG. 7 in the screen upward direction, to thereby make the content C23 arranged in the arrangement area C23a invisible from the lower end to the upper end.

Furthermore, after making the content C23 invisible, the terminal device 100 moves the lower end of the visible area C22b indicated by (E) in FIG. 7 in the screen upward direction, to thereby gradually make the content C22 arranged in the arrangement area C22a invisible from the lower end to the upper end. Then, after making the content C22 invisible, the terminal device 100 moves the lower end of the visible area C21b indicated by (F) in FIG. 7 in the screen upward direction, to thereby gradually make the content C21 arranged in the arrangement area C21a invisible from the upper end to the lower end.

If the content C23 including the content C22 as a part thereof is arranged behind the content C22, and the content C23 is gradually made invisible from the lower end thereof in the screen upward direction, the terminal device 100 can display the content C22 and the content C23 such that the the contents C22 and C23 look seamless. However, the terminal device 100 may display different ranges of the content C20 as the contents C21 to C23. For example, if three contents equally divided from the upper end of the content C20 are displayed as the contents C21 to C23, the terminal device 100 may arrange the arrangement areas C21a to C23a next to one another from the upper end of the screen. Even when the above-described setting is performed, the terminal device 100 can implement the same display mode as the display mode obtained when the setting illustrated in FIG. 7 is performed.

8. Variations of Display Process

An example of the display process performed by the terminal device 100 has been described above by using the display mode illustrated in FIG. 1. However, the embodiment is not limited to this example. Variations of the display process performed by the terminal device 100 will be described below. The display process described below is implemented by, for example, a process performed by the display unit 155 and the area control unit 156. However, the embodiment is not limited to this example.

8-1. First Variation

The above-described terminal device 100 sets the visible areas that start from the upper end of the web page C10, and displays each of the contents C21 to C23 in the initial screen. Furthermore, the above-described terminal device 100 overlaps the respective visible areas of the contents C21 to C23, sets the lower ends of the respective visible areas at different positions, and reduces the display areas at different timings. However, the embodiment is not limited to this example.

For example, a user may set the arrangement area of the content C20 at the upper end of the screen and set the visible area in the middle of the web page C10. If the above-described setting is performed, the arrangement area and the visible area of the content C20 do not overlap each other in the initial screen, so that the content C20 is not displayed and only the web page C10 is displayed. Then, the terminal device 100 displays the content C20 such that when an upward scroll operation is performed, the terminal device 100 moves the lower end of the display area of the content C20 in the screen upward direction without moving the content C20 to thereby gradually expand the display area, and, when the upward scroll operation is further performed, the terminal device 100 gradually reduces the display area in the screen upward direction.

Therefore, the terminal device 100 displays only the web page C10 without displaying the content C20 in the initial screen, so that the user is not prevented from viewing the web page C10. Consequently, it is possible to prevent the user from getting a negative impression of the content C20. Furthermore, the terminal device 100 gradually displays the content C20 from the lower end to the upper end when a scroll operation is performed, and thereafter gradually makes the content C20 invisible from the lower end to the upper end. Therefore, the terminal device 100 can prevent the user from getting a negative impression of the content C20 and improve the appeal of the information related to the content C20.

Moreover, for example, the user may set the arrangement areas of a plurality of the contents C31 and C32 of the same size at the same position, and may perform setting such that the lower end of the visible area of the content C31 and the upper end of the visible area of the content C32 come in contact with each other. If the above-described setting is performed, the terminal device 100 displays the content C31 by gradually expanding the display area of the content C31 from the screen downward direction to the screen upward direction in accordance with an upward scroll operation.

Furthermore, if the upward scroll operation is further performed, the terminal device 100 moves the lower end of the display area of the content C31 in the screen upward direction, and simultaneously moves the upper end of the display area of the content C32 in the screen upward direction within an area in which the content C31 is displayed. Moreover, if the upward scroll operation is further performed, the terminal device 100 gradually reduces the display area of the content C32. By performing the above-described process, the terminal device 100 can switch from the content C31 to the content C32 in the same area on the screen in accordance with the scroll operation.

8-1-1. Setting of Visible Area and Arrangement Area

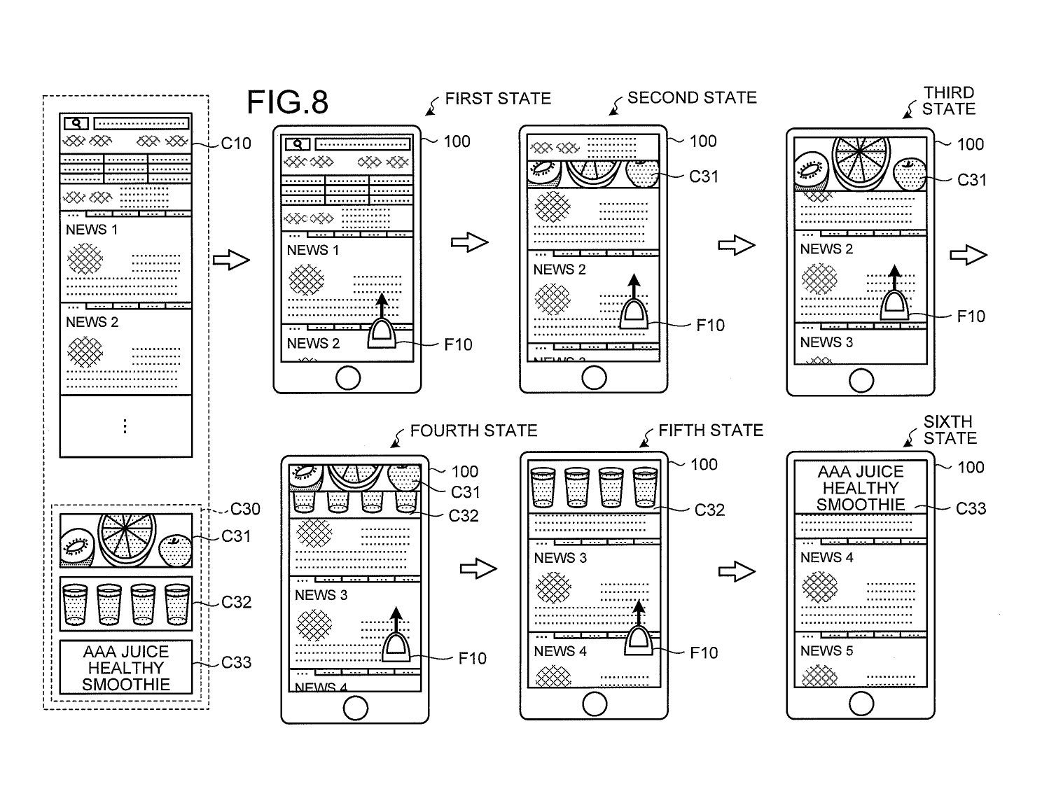

An example of variations of the display process will be described below with reference to FIG. 8. FIG. 8 is a diagram illustrating a first variation of the display process performed by the terminal device according to the embodiment. In the following description, an example of the display process performed by the terminal device 100 to switch a content in the same area will be described in multiple parts, from a first state to a sixth state.

For example, as illustrated in FIG. 8, the terminal device 100 accepts distribution of the web page C10 that does not include the space C11 at the upper end thereof, and a content C30 including contents C31 to C33 of the same size. It is assumed that each of the contents C31 to C33 is a content related to advertisement, similarly to the contents C21 to C23.

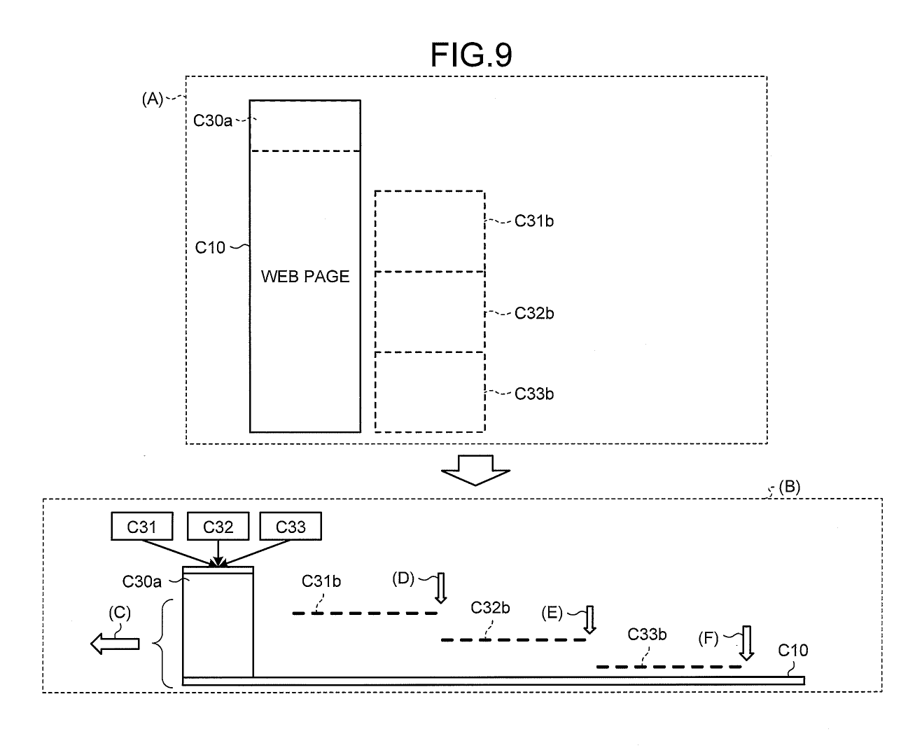

The respective arrangement areas of the contents C31 to C33 are set in the same area on the screen, and the respective visible areas of the contents C31 to C33 are arranged so as not to overlap each other. For example, FIG. 9 is a diagram for explaining a variation of setting of the arrangement area and the visible areas. In the example illustrated in (A) in FIG. 9, an arrangement area C30a as the arrangement area of each of the contents C31 to C33 is set from the upper end of the web page C10 so as to have the same size as the display size of each of the contents C31 to C33.

Furthermore, in the example illustrated in (A) in FIG. 9, visible areas C31b to C33b of the contents C31 to C33 are set from the middle of the web page C10. Incidentally, the upper end of the visible area C32b is arranged so as to come in contact with the lower end of the visible area C31b, and the upper end of the visible area C33b is arranged so as to come in contact with the lower end of the visible area C32b.

In this case, as illustrated in (B) in FIG. 9, the terminal device 100 arranges, in the arrangement area C30a, each of the contents C31 to C33 in an invisible state, and arranges the web page C10 behind the contents C31 to C33. In the example illustrated in (B) in FIG. 9, dotted lines schematically representing the visible areas C31b to C33b are arranged between the arrangement area C30a and the web page C10. Then, as indicated by (C) in FIG. 9, the terminal device 100 moves the web page C10 and each of the visible areas C31b to C33b in accordance with a scroll operation.

If the above-described process is performed, the visible area C31b among the visible areas C31b to C33b first overlaps the arrangement area C30a. Therefore, the terminal device 100 gradually makes the content C31 visible from the lower end to the upper end in the arrangement area C30a without moving the content C31.

Then, in accordance with the movement of the lower end of the visible area C31b and the upper end of the visible area C32b indicated by (D) in FIG. 9 in the screen upward direction, the terminal device 100 gradually makes the content C31 invisible from the lower end to the upper end and gradually makes the content C32 visible from the lower end to the upper end in the arrangement area C30a. That is, the terminal device 100 moves the lower end of the display area of the content C31 in the screen upward direction and moves the upper end of the display area of the content C32 in the upward direction in the same arrangement area C30a.

Furthermore, in accordance with the movement of the lower end of the visible area C32b and the upper end of the visible area C33b indicated by (E) in FIG. 9 in the screen upward direction, the terminal device 100 gradually makes the content C32 invisible from the lower end to the upper end and gradually makes the content C33 visible from the lower end to the upper end in the arrangement area C30a. That is, the terminal device 100 moves the lower end of the display area of the content C32 in the screen upward direction and moves the upper end of the display area of the content C33 in the upward direction in the same arrangement area C30a.

Then, in accordance with the movement of the lower end of the visible area C33b indicated by (F) in FIG. 9, the terminal device 100 gradually makes the content C33 invisible from the lower end to the upper end in the arrangement area C30a, to thereby gradually reduce the display area of the content C33 from the screen downward direction to the screen upward direction.

8-1-2. Example of Display Process for Switching Between Contents

Referring back to FIG. 8, an example of a display process performed by the terminal device 100 to switch between the contents C31 to C33 in accordance with a scroll operation will be described below. In the following description, it is assumed that the upper end of the visible area C31b is arranged at the position of the upper end of the “news 1”, and the lower end of the visible area C31b and the upper end of the visible area C32b are arranged at the position of the upper end of the “news 2”. It is also assumed that the lower end of the visible area C32b and the upper end of the visible area C33b are arranged at the position of the upper end of the “news 3”, and the lower end of the visible area C33b is arranged at the position of the upper end of the “news 4”.

First, the terminal device 100 accepts distribution of the web page C10 and the content C30. In this case, the terminal device 100 displays the web page C10 and arranges the content C20 in the arrangement area C30a. Therefore, as illustrated in the first state, the terminal device 100 displays only the web page C10 in a visible state.

If the user performs an upward scroll operation on the web page C10 with the finger F10, the terminal device 100 scrolls the web page C10 in the screen upward direction. If the upper end of the “news 1” contained in the web page C10 is moved in the screen upward direction relative to the lower end of the arrangement area C30a, the terminal device 100 expands the display area of the content C31 by making the content C31 visible from the lower end to the upper end in accordance with the position of the upper end of the “news 1” as illustrated in the second state. Then, the terminal device 100 gradually expands the display area of the content C31 in accordance with the upward scroll operation, and makes the entire content C31 visible as illustrated in the third state.

Furthermore, when the entire content C31 is displayed, and if the upward scroll operation is further performed and the upper end of the “news 2” contained in the web page C10 is moved in the screen upward direction relative to the lower end of the arrangement area C30a, the terminal device 100 performs a process as described below. Specifically, as illustrated in the fourth state, the terminal device 100 makes the content C31 invisible from the lower end to the upper end in accordance with the position of the upper end of the “news 2” and simultaneously makes the content C32 visible from the lower end to the upper end in accordance with the position of the upper end of the “news 2”.

That is, the terminal device 100 reduces the display area of the content C31 from the screen downward direction to the upward direction without moving the content C31, and expands the display area of the content C32 from the screen downward direction to the upward direction without moving the content C32. Then, the terminal device 100 gradually reduces the display area of the content C31 and gradually expands the display area of the content C32 in accordance with the upward scroll operation, to thereby make the entire content C32 visible as illustrated in the fifth state.

Furthermore, if the upward scroll operation is further performed and the upper end of the “news 3” contained in the web page C10 is moved in the screen upward direction relative to the lower end of the arrangement area C30a, the terminal device 100 makes the content C32 invisible from the lower end to the upper end in accordance with the position of the upper end of the “news 3” and simultaneously makes the content C33 visible from the lower end to the upper end in accordance with the position of the upper end of the “news 3”.

Then, the terminal device 100 gradually reduces the display area of the content C32 and gradually expands the display area of the content C33 in accordance with the upward scroll operation, to thereby make the entire content C33 visible as illustrated in the sixth state. When the entire content C33 is displayed, and if the upward scroll operation is further performed, the terminal device 100 makes the content C33 invisible from the lower end to the upper end, to thereby make the content C30 invisible.

As described above, the terminal device 100 can display the contents C31 to C33 in a complicated mode such that the content C31 is switched to the content C32 and then the content C32 is switched to the content C33 from the screen downward direction to the screen upward direction in the same area in accordance with the upward scroll operation performed on the web page C10. Therefore, the terminal device 100 can improve the appeal effect of information related to each of the contents C31 to C33.

If a downward scroll operation is performed, the terminal device 100 switches the displayed content in order from the contents C33 to C31 in accordance with the downward scroll operation as illustrated in the sixth state to the first state. For example, in the example illustrated in FIG. 9, if the downward scroll operation is performed, the terminal device 100 gradually makes the content C33 visible from the upper end to the lower end in the arrangement area C30a. Subsequently, the terminal device 100 gradually makes the content C33 invisible from the upper end to the lower end and gradually makes the content C32 visible from the upper end to the lower end. Furthermore, the terminal device 100 gradually makes the content C32 invisible from the upper end to the lower end, gradually makes the content C31 visible from the upper end to the lower end, and thereafter gradually makes the content C31 invisible from the upper end to the lower end.

8-2. Second Variation

The above-described terminal device 100 performs the above-described various display processes by setting the arrangement area and the visible area of each of the contents C21 to C23 and C31 to C33. However, the embodiment is not limited to this example.

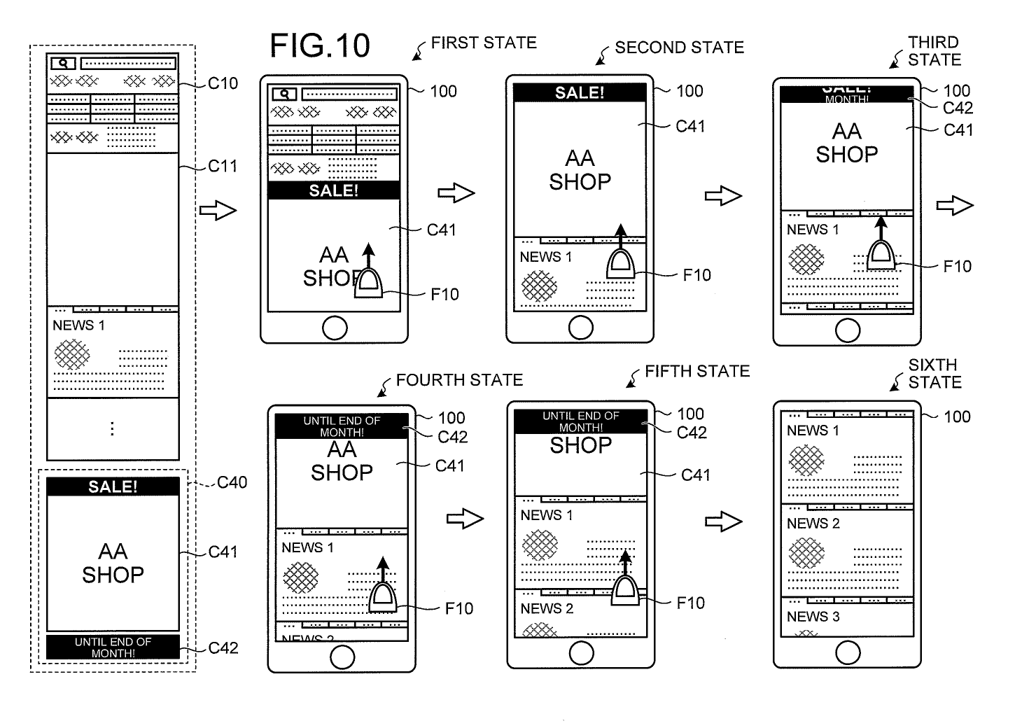

For example, FIG. 10 is a diagram illustrating a second variation of the display process performed by the terminal device according to the embodiment. In the following description, an example of a process performed by the terminal device 100 to change the display of a content C40 in the same area will be described in multiple parts, from a first state to a sixth state.

For example, as illustrated in FIG. 10, the terminal device 100 accepts distribution of the web page C10 and the content C40. In the web page C10, the space C11 for displaying the content C40 is provided, and the content C40 is arranged in the space C11. The content C40 is configured with a content C41 and a content C42.

The content C41 includes an area in which characters such as “SALE!” are arranged, and an area in which characters such as “AA shop” are arranged. The content C42 is a content that has the same display size as that of the area of the content C41 in which the characters “SALE!” are arranged. In the content C42, characters such as “until end of month!” are arranged.

In this case, as illustrated in the first state, the terminal device 100 arranges the content C41 in the space C11 of the web page C10 and displays the web page C10 and the content C41. Then, as illustrated in the second state, the terminal device 100 scrolls the web page C10 and the content C41 in accordance with an upward scroll operation performed by the user with the finger F10.

It is assumed that the arrangement area of the content C42 is arranged at the upper end of the screen, and the visible area of the content C42 is arranged in the area of the content C41 in which the characters “AA shop” are arranged In this case, the terminal device 100 moves the content C41 from the upper end of the screen to the outside of the screen and gradually makes the content C42 visible from the lower end to the upper end in accordance with the upward scroll operation.

Consequently, as illustrated in the third state, the terminal device 100 can implement a complicated display mode such that the terminal device 100 gradually reduces the display area of the characters “SALE!” while moving the characters “SALE!” in the screen upward direction, and expands the display area of the content C42 from the screen downward direction to the screen upward direction without moving the content C42.

If the upward scroll operation is further performed, the terminal device 100 makes the entire content C42 visible as illustrated in the fourth state. If the upward scroll operation is further performed, the terminal device 100 displays the content C40 so as to move the content C41 arranged on the back side in the screen upward direction without moving the display area of the content C42.

If the upward scroll operation is further performed, the terminal device 100 moves the entire content C41 to the outside of the screen and gradually makes the content C42 invisible from the lower end to the upper end in accordance with the position of the lower end of the content C41 without moving the content C42. Therefore, the terminal device 100 displays only the web page C10 as illustrated in the sixth state.

8-3. Display Process According to Scroll Direction

When an upward scroll operation is performed, the above-described terminal device 100 gradually reduces the display area of the content C20 from the screen downward direction to the screen upward direction. However, the embodiment is not limited to this example. For example, if a downward scroll operation is performed, the terminal device 100 may gradually reduce the display area of the content C20 from the screen upward direction to the screen downward direction. Furthermore, if a scroll operation is performed in the horizontal direction from the left side to the right side of the screen, the terminal device 100 may gradually reduce the display area of the content C20 from the left side to the right side without moving the content C20. That is, the terminal device 100 may gradually reduce the display area in accordance with a scroll operation in an arbitrary direction without moving the content C20.

8-4. Setting of Visible Area

The terminal device 100 may employ an arbitrary mode in addition to the modes described above, as long as it is possible to gradually reduce the display areas of the contents C20 to C40 in a direction in which a scroll operation is performed without moving the contents C20 to C40. For example, the terminal device 100 may not overlap the visible areas C21b to C21b of the contents C21 to C23, but may set a distance from the lower end of the visible area C21a to the lower end of the visible area C22b and a distance from the lower end of the visible area C21b to the lower end of the visible area C23b to different distances.

Furthermore, the terminal device 100 may not arrange the visible areas C31b to C33b of the contents C31 to C33 such that the visible areas come in contact with each other. Moreover, the terminal device 100 may set the visible areas such that only parts of the contents C20 to C40 are displayed. For example, the terminal device 100 may set a visible area whose display size in the horizontal direction is shorter than that of the content C20 so that only a part of the content C20 is displayed.

8-5. Visible Area

The above-described terminal device 100 sets the visible area in which the contents C20 to C40 are made visible. However, the embodiment is not limited to this example. For example, the terminal device 100 may set a range, in which transparency, saturation, brightness, or the like of a range of the contents C20 to C40 overlapping the arrangement area is to be changed. Furthermore, if the contents C20 to C40 are moving images, the terminal device 100 may set an area in which a playback mode of the moving images, such as playback or stop of the moving images, is controlled.

8-6. Arrangement Area

The above-described terminal device 100 sets the arrangement areas C21a to C23a and C30a in the upper part of the screen. However, the embodiment is not limited to this example. That is, the terminal device 100 can set the arrangement area in an arbitrary location on the screen. For example, the terminal device 100 can set the arrangement area in an arbitrary location, such as a lower part, a left part, a right part, or a center part, on the screen. Furthermore, the terminal device 100 may arrange a plurality of the arrangement areas C21a of the contents C21 in the screen. In this case, the terminal device 100 simultaneously changes the display modes of the contents C21 at a plurality of positions in the screen.

8-7. Others

The terminal device 100 may perform the display process by appropriately combining the above-described processes. The combination may be arbitrarily set, as a display instruction, by an advertiser when an advertisement content is registered in the advertisement distribution server 20. The advertisement distribution server 20 generates control information for causing the terminal device 100 to perform the combination of the processes set by the advertiser, and distributes the generated control information to the terminal device 100. Therefore, the terminal device 100 can combine and perform the arbitrary processes described above in accordance with the setting performed by the advertiser.

9. Flow of Process Performed by the Terminal Device 100

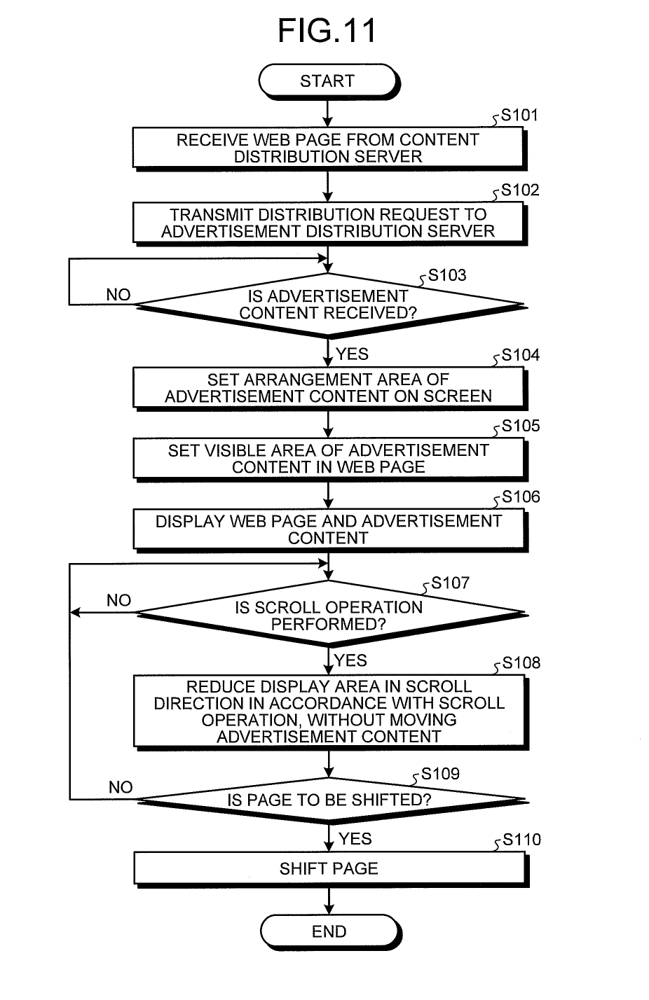

The flow of a process performed by the terminal device 100 that executes the control information will be described below with reference to FIG. 11. FIG. 11 is a flowchart illustrating an example of the flow of the display process performed by the terminal device according to the embodiment. In the example illustrated in FIG. 11, a process will be described in which a content, such as the content C20, distributed from the advertisement distribution server 20 is used as an advertisement content.

In the example illustrated in FIG. 11, the terminal device 100 requests the content distribution server 30 to distribute the web page C10 in accordance with an operation performed by a user, and receives the web page C10 from the content distribution server 30 (Step S101). Subsequently, if the distributed web page C10 includes an acquisition command, the terminal device 100 transmits a distribution request to the advertisement distribution server 20 (Step S102). Then, the terminal device 100 determines whether an advertisement content is received (Step S103). If the terminal device 100 determines that the advertisement content is not received (NO at Step S103), the process at Step S103 is repeated.

If the terminal device 100 receives the advertisement content (YES at Step S103), the terminal device 100 sets an arrangement area of the advertisement content on the screen (Step S104). Furthermore, the terminal device 100 sets a visible area of the advertisement content in the web page C10 (Step S105). Then, the terminal device 100 displays the web page C10 and the advertisement content (Step S106). In the process at Step S106, only a range of the advertisement content in which the arrangement area and the visible area overlap each other is displayed. For example, in the example illustrated in FIG. 1, the terminal device 100 displays the entire content C20.

Furthermore, the terminal device 100 determines whether a scroll operation is performed (Step S107), and if the scroll operation is performed (YES at Step S107), the terminal device 100 reduces the display area in the scroll direction in accordance with the scroll operation, without moving the advertisement content (Step S108). For example, in the example illustrated in FIG. 1, the terminal device 100 gradually reduces the display area of the content C20 in the screen upward direction without moving the content C20.

Furthermore, the terminal device 100 determines whether to shift the web page through a process of tapping a link or the like performed by the user (Step S109). If the terminal device 100 determines to shift the web page (YES at Step S109), the terminal device 100 shifts the web page (Step S110), and the process ends.

In contrast, if the terminal device 100 determines not to shift the web page (Step S109: No), the terminal device 100 performs the process at Step S107. If the scroll operation is not performed (NO at Step S107), the terminal device 100 repeats the process at Step S107.

10. Modifications

An example of the display process performed by the terminal device 100 has been described above by using the display modes illustrated in FIG. 1, FIG. 8, and FIG. 10. However, the embodiment is not limited to this example. Variations of the display process performed by the terminal device 100 will be described below. It is assumed that the display process described below is implemented by, for example, a process performed by the arranging unit 154, the display unit 155, and the area control unit 156.

10-1. Mode of Content

The above-described terminal device 100 displays a plurality of the contents C21 to C23 included in the content C20. However, the embodiment is not limited to this example. For example, the contents C21 to C23 may be contents related to different advertisements. Furthermore, the terminal device 100 may display the content C20 configured to provide different contents between when the content C20 includes the contents C21 to C23, when the content C20 includes the contents C21 and C22, and when the content C20 includes only the content C21.

10-2. Content

In the above description, an example has been described in which the terminal device 100 displays the contents C20 to C40 related to advertisement. However, the embodiment is not limited to this example. For example, the terminal device 100 may display a content including a character string, a pattern, an image, a moving image, or the like. Furthermore, the terminal device 100 may display the contents C20 to C40 including a game or the like, instead of a content related to advertisement, or may display the contents C20 to C40 including a so-called playable advertisement. Moreover, the terminal device 100 may display the contents C20 to C40 including audio. The character string, the pattern, the image, the moving image, the game, the audio, and the like included in the contents C20 to C40 are not limited to those related to advertisement.

Furthermore, the content C20 is not limited to the content related to advertisement. For example, when displaying a game content instead of the web page C10, the terminal device 100 may display, as the contents C20 to C40, an auxiliary content, such as a game menu or a game tutorial. Moreover, when displaying an interactive web page generated by a technology using flash, CSS, or the like at the time of execution of the game, the terminal device 100 may display the contents C20 to C40 and perform the display process.

Furthermore, the terminal device 100 may display the contents C20 to C40 together with a content of a social networking service (SNS), a screen of a messenger application, a screen of a camera application, or any other content, and thereafter, may perform the display process as described above. Moreover, the terminal device 100 may display an arbitrary content, such as a game, a map, a music playback screen, or a video playback screen, in addition to the web page C10.

10-3. Control Information

The above-described terminal device 100 performs the above-described display process by using the control information that is distributed from the advertisement distribution server 20 together with the content C20. However, the embodiment is not limited to this example. For example, the terminal device 100 receives the above-described control information from the content distribution server 30 together with the web page, and receives a control instruction from the advertisement distribution server 20 together with the content C20. Then, the terminal device 100 may execute the control information received from the content distribution server 30, and perform the display process in accordance with the received control instruction.

Furthermore, the terminal device 100 may download, in advance, an application for causing the terminal device 100 to perform a process of displaying the web page C10, the above-described display process, and the like, and may implement the above-described processes by executing the application.

10-4. Configuration of Apparatus

In the above-described embodiment, an example has been described in which the distribution system 1 includes the advertisement distribution server 20 and the content distribution server 30. However, the advertisement distribution server 20 and the content distribution server 30 may be configured as a single device. In this case, the advertisement distribution server 20 illustrated in FIG. 3 includes, for example, the content storage unit 32, the accepting unit 34, and the distribution unit 35 illustrated in FIG. 5. The advertisement distribution server 20, upon accepting an acquisition request for a web page from the terminal device 100, distributes an advertisement content and a web page that does not include an acquisition command to the terminal device 100.

In the above-described embodiment, an example has been described in which the advertisement distribution server 20 distributes the content C20 to the terminal device 100. However, the content distribution server 30 may acquire the content C20 from the advertisement distribution server 20. In this case, the request accepting unit 26 of the advertisement distribution server 20 accepts an acquisition request for the content C20 from the content distribution server 30. The advertisement distribution server 20 distributes the content C20 to the content distribution server 30. The content distribution server 30 distributes the content C20 acquired from the advertisement distribution server 20 and a web page that does not include an acquisition command to the terminal device 100.

10-5. Log

The terminal device 100 may acquire a log indicating whether the contents C20 to C40 are displayed, or a log of a content selected by a user. Furthermore, the terminal device 100 may measure, for each image, a time at which the user performs a selection, in addition to the number of displays or the number of selections of the contents C20 to C40. Moreover, the terminal device 100 may acquire a log indicating whether the contents C20 to C40 are displayed from the initial screen or whether the entire contents C20 to C30 are hidden. Furthermore, the terminal device 100 may acquire a log indicating whether all of the contents C20 to C40 are displayed. Moreover, the terminal device 100 may acquire a log indicating whether the contents C21 to C23, C31 to C33, C41, and C42 are displayed, whether the display areas are reduced, or whether the display areas are expanded, or a log indicating the number of displays or the like. Furthermore, the terminal device 100 may acquire a log indicating the number of times each of the contents C20 to C40 is displayed by a single access to the web page C10, the number of operations, or the like.

For example, if a user ends the display of the web page C10 without performing a scroll operation, the terminal device 100 may acquire a log indicating that the content C30 is not viewed. In contrast, if the user performs an upward scroll operation from the initial screen and expands the display area of the content C31, the terminal device 100 may acquire a log indicating that the content C31 is displayed. Furthermore, the terminal device 100 may acquire a log indicating whether the user has selected the contents C21 to C23 or whether the user has performed a selection while any of the contents C21 to C23 is displayed.

The log acquired by the terminal device 100 as described above is useful when the number of impressions or the CTR of the contents C20 to C40 is updated, when a charging process for display of the contents C20 to C40 is performed, and when an advertising effect is reported to the advertiser. For example, if the content C20 is in the hidden state and is not displayed again at a later time, it is expected that the user is not interested in the content C20. Furthermore, when the contents C21 to C23 are displayed a number of times or when the upward scroll operation and the downward scroll operation are performed a number of times, it is expected that the user is interested in the contents C20 to C40 and has changed the display mode a number of times. Therefore, a log indicating a change in the display modes of the contents C20 to C40 or a log indicating a scroll operation from the initial screen can be an index of whether the user is interested in the contents C20 to C40. Furthermore, the number of times each of the contents C20 to C40 is displayed or operated by a single access can be an index of user's awareness of the advertisement.

Therefore, the advertisement distribution server 20 may update the number of impressions or may change the amount of fees by using each of the acquired logs. For example, the advertisement distribution server 20 may change the amount of fees depending on whether a scroll operation in the downward direction is performed from an initial image and the display areas of the contents C20 to C40 are expanded or reduced, whether the display modes of the contents C20 to C40 are changed, or whether a moving image contained in the contents C20 to C40 is reproduced, or depending on the number of the scroll operations or the like.

Furthermore, the log acquired by the terminal device 100 may be used to change a content arranged in the landing page. For example, when the user selects the content C20, the terminal device 100 may provide a different landing page depending on the size of the display area of the content C20, or depending on whether the display mode of the content C20 is changed to the final state. Moreover, the terminal device 100 may acquire the same landing page, provide, to a server that distributes the landing page, the size of the display area of the content C20 or a notice indicating whether the display mode of the content C20 is changed to the final state, and cause the server to change contents arranged in the landing page.

10-6. Operation Record of Terminal Device

The above-described terminal device 100 may transmit, to the advertisement distribution server 20, a record indicating the degree of operations that a user has performed on the terminal device 100 with respect to a web page in which the contents C20 to C40 according to the embodiment are arranged. Specifically, the terminal device 100 records the contents of scroll operations performed when the contents C20 to C40 are arranged, the number of times of the scroll operations, a selection operation performed by the user, positions at which the user selects the contents C20 to C40, display modes of the selected contents C20 to C40, playback status of moving images included in the contents C20 to C40, and the like.

Furthermore, the terminal device 100 may record various operations such as the number of selections of the contents C20 to C40, the number of times of reload, an operation of transmitting information for identifying the contents C20 to C40 from the terminal device 100 (for example, writing in an SNS or the like), which is performed by the user on the terminal device 100. The terminal device 100 transmits information on the operation history to the advertisement distribution server 20.

In this case, the advertisement distribution server 20 aggregates information on the operation history distributed from the terminal device 100, and further acquires information obtained by analyzing the aggregated information. For example, the advertisement distribution server 20 acquires the number of scroll operations performed on the web pages C10, the number of executions of the display process, a type of the displayed landing page, a type of a content arranged in the landing page, information on comparison of indices, such as CTRs, of the advertising effect, for both of the case where the contents C20 to C40 are distributed together with the control information and the case where the contents C20 to C40 are not distributed together with the control information.

The history of operations performed on the web page C10 when the contents C20 to C40 are distributed together with the control information may be used as an index of the advertising effect. That is, in the web page in which the contents C20 to C40 including the control information according to the embodiment are displayed, not only the fact that a user clicks the contents C20 to C40 and a web page (landing page) linked from the contents C20 to C40 is displayed, but also the operation history itself indicating the number of operations performed by the user on the web page C10 (that is, the number of times that the user changes the display mode of the screen) may be used as an index of the user's interest in the contents C20 to C40.

For example, when a user performs an upward scroll operation from the initial screen, the advertisement distribution server 20 compares the number of times each of the contents C21 to C23, C31 to C33, C40, and C41 is displayed or a time during which each of the contents C21 to C23, C31 to C33, C40, and C41 is displayed, so that it is possible to provide an index indicating the degree of interest in information expected to be broadly conveyed by the contents C20 to C40 when the contents C20 to C40 with the control information according to the embodiment are displayed, that is, it is possible to provide an index indicating the degree of interest in the advertisement.

Therefore, by transmitting the information on the operation history of the terminal device 100 to the advertiser terminal 10, the advertisement distribution server 20 can provide a report indicating the index of the advertising effect of the web page C10 in which the contents C20 to C40 according to the embodiment are displayed. The advertisement distribution server 20 may directly transmit the information or the log on the operation history of the terminal device 100 to the advertiser terminal 10.

Consequently, the advertisement distribution server 20 can provide an advertiser with indication of how the display modes of the contents C20 to C40 with the control information according to the embodiment are useful in the terminal device 100.

10-7. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to the information illustrated in the drawings.

The components of the apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the requesting unit 151 and the operation control unit 152 illustrated in FIG. 6 may be integrated with each other.

Furthermore, the embodiments described above may be combined appropriately as long as the processes do not conflict with each other.

10-8. Program

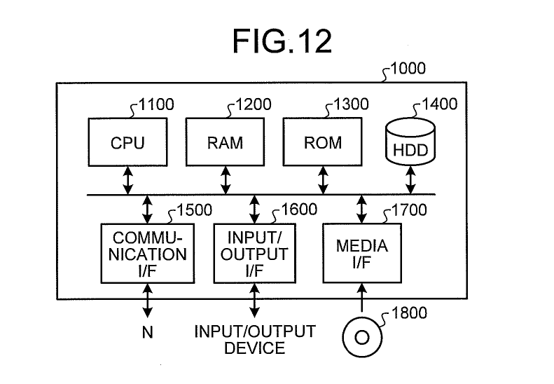

The terminal device 100, the advertisement distribution server 20, and the content distribution server 30 according to the above-described embodiment are implemented by, for example, a computer 1000 with a configuration as illustrated in FIG. 12. In the following, a description will be given by using the advertisement distribution server 20 as an example. FIG. 12 is a diagram illustrating an example of a hardware configuration of a computer that implements the functions of the advertisement distribution server. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via the network N, sends the data to the CPU 1100, and transmits data generated by the CPU 1100 to other devices.

The CPU 1100 controls an output device, such as a display or a printer, an input device, such as a keyboard or a mouse, and the like via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200. The CPU 1100 loads the program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the advertisement distribution server 20 according to the embodiment, the CPU 1100 of the computer 1000 implements the functions of the control unit 23 by executing the program loaded on the RAM 1200. Furthermore, the HDD 1400 stores therein data stored in the storage unit 22, that is, the advertisement database 24. While the CPU 1100 of the computer 1000 reads the program from the recording medium 1800 and executes the program, the program may be acquired from other devices as another example.

When the computer 1000 functions as the terminal device 100 according to the embodiment, the CPU 1100 of the computer 1000 implements the functions of the control unit 150 by executing the program loaded on the RAM 1200.

When the computer 1000 functions as the content distribution server 30 according to the embodiment, the CPU 1100 of the computer 1000 implements the functions of the control unit 33 by executing the program loaded on the RAM 1200. The HDD 1400 stores therein data in the content storage unit 32.

11. Advantageous Effects

As described above, the terminal device 100 displays the web page C10 as an example of a first content and the content C20 as an example of a second content. If an upward scroll operation is performed, the terminal device 100 reduces the display area of the content C20 in the screen upward direction without moving the content C20, to thereby expand an area in which the web page C10 is displayed.

Therefore, if a user continues the upward scroll operation, the terminal device 100 makes the content C20 invisible and expands the display area of the web page C10, so that it is possible to prevent the user from getting a negative impression of the content C20 and make the user aware of the content C20. Consequently, the terminal device 100 can cause the content C20 to attract attention of the user who is interested in the content C20, and improve the appeal of the information related to the content C20.

More specifically, when the content C20 related to advertisement is displayed, the terminal device 100 can attract interest of the user in the content C20 related to advertisement, so that it is possible to improve the appeal of the information expected to be conveyed by the content C20, that is, the appeal of an advertisement content, and improve the advertising effect.

Furthermore, the terminal device 100 moves the lower end of the display area of the content C20 in the screen upward direction in accordance with an upward scroll operation performed on the web page C10. Therefore, the terminal device 100 hides the content C20 in a mode such that the lower end of the content C20 is gradually moved in the upward direction. Consequently, it is possible to attract interest of the user in the content C20.

Moreover, the terminal device 100 arranges a plurality of the contents C21 to C23 next to one another and separately reduces the display area of each of the contents C21 to C23 in accordance with a scroll operation. Therefore, the terminal device 100 can attract interest of the user in each of the contents C21 to C23 while preventing the user from getting a negative impression of the contents C21 to C23.

Furthermore, the terminal device 100 reduces the respective display areas of the contents C21 to C23 at different timings, and hides the contents C21 to C23 in a complicated mode such that the contents C21 to C23 are gradually reduced from the lower ends thereof. Therefore, it is possible to improve the appeal effect of the information related to the content C20 with respect to the user.

For example, the terminal device 100 gradually reduces the display areas in order of the content C23, the content C22, and the content C21 in accordance with a scroll operation. Therefore, the terminal device 100 can gradually reduce the display mode of the content C20 including the contents C21 to C23 in accordance with the scroll operation.

If the above-described display process is performed, the terminal device 100 can improve the appeal effect of the information related to the content C20 with respect to the user. For example, if the content C20 is displayed as a single content, the terminal device 100 continues to display the content C20 on the screen or hides the content C20 in accordance with the scroll operation. However, the terminal device 100 displays a plurality of the contents C21 to C23 and gradually reduces the respective display areas of the contents C21 to C23 at different timings in accordance with the scroll operation, so that the content C20 is gradually hidden. Therefore, for example, when the terminal device 100 displays a content or the like whose display size in the vertical direction is long, the terminal device 100 displays the entire content and also gradually reduces the display area in accordance with a scroll operation. Consequently, it is possible to prevent the user from getting a negative impression of the content and improve the appeal effect of the information related to the content.

Moreover, the terminal device 100 arranges the content C20, which is another example of the second content, in an invisible state in the screen, and if a scroll operation is performed while the content C30 is in the invisible state, the terminal device 100 expands the display area of the content C30 in a direction in which the scroll operation is performed, without moving the content C30, to thereby expand the area in which the web page C10 is displayed.

Therefore, the terminal device 100 displays only the web page C10 in the initial screen, and thereafter displays the content C30 in accordance with a scroll operation, so that it is possible to prevent a reduction in the visibility of the web page C10 in the initial screen and make the user aware of the content C30. Consequently, the terminal device 100 can improve the appeal effect of the information related to the content C30.

Furthermore, if an upward scroll operation is performed on the web page C10 while the content C30 is in the invisible state, the terminal device 100 moves the upper end of the display area of the content C30 in the screen upward direction. Therefore, the terminal device 100 can implement a complicated mode such that the terminal device 100 gradually displays the content C30 from the lower end in accordance with the upward scroll operation without moving the content C30. Consequently, the terminal device 100 can improve the appeal effect of the information related to the content C30.

Moreover, for example, the terminal device 100 arranges the content C32 with the same display size as the content C31 that is an example of the second content, at the same position and in an invisible state. Then, the terminal device 100 reduces the display area of the content C31 in a direction in which the scroll operation is performed, and simultaneously expands the display area of the content C32 in the direction in which the scroll operation is performed, without moving the content C32.

Therefore, the terminal device 100 can switch between the contents C31 and C32 in a complicated mode such that the content C31 is gradually switched to the content C32 from the lower end to the upper end in accordance with upward scroll. Consequently, the terminal device 100 can improve the appeal effect of the information related to the content C30.

Furthermore, if a scroll operation is performed while the entire content C31 is displayed, the terminal device 100 reduces the display area of the content C31 in a direction in which the scroll operation is performed, and simultaneously expands the display area of the content C32 in the direction in which the scroll operation is performed, without moving the content C32. Therefore, the terminal device 100 can cause the user to view the entire content C31.

Moreover, if a scroll operation is performed while the entire content C33 as an example of the third content is displayed, the terminal device 100 reduces the display area of the content C33 in a direction in which the scroll operation is performed, to thereby expand the area in which the web page C10 is displayed. Therefore, the terminal device 100 can attract interest of the user to each of the contents C31 to C33 while preventing the user from getting a negative impression of each of the contents C31 to C33.

Furthermore, the advertisement distribution server 20 distributes the control information to the terminal device 100. The control information causes the terminal device 100 to perform a process of displaying the web page C10 and the content C20, and if an upward scroll operation is performed, causes the terminal device 100 to perform a process of reducing the display area of the content C20 in the screen upward direction without moving the content C20, to thereby expand the area in which the web page C10 is displayed. Therefore, the advertisement distribution server 20 can attract interest of the user in each of the contents C21 to C23 while preventing the user from getting a negative impression of each of the contents C21 to C23.

While the embodiments of the present invention have been described above in detail, these embodiments are mere examples, and the present invention may be embodied in various different forms including modifications based on the knowledge of those skilled in the art, other than the above-described embodiments.

Furthermore, “a unit” recited in the claims may be replaced with “a section, a module, or a means” or “a circuit”. For example, the distribution unit may be replaced with a distribution means or a distribution circuit.

According to an embodiment of the present invention, it is possible to improve an appeal effect of information related to a content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display apparatus comprising:
a display unit that displays a first content and a second content different from the first content; and
a control unit that, when a moving operation is performed on the first content, reduces a display area of the second content in a direction in which the moving operation is performed, without moving the second content, to thereby expand an area in which the first content is displayed.

2. The information display apparatus according to claim 1, wherein the control unit moves a lower end of the display area of the second content in a screen upward direction in accordance with a moving operation of moving the first content in the screen upward direction.

3. The information display apparatus according to claim 1, wherein
the display unit arranges a plurality of the second contents next to one another, and
the control unit separately reduces the display area of each of the second contents in accordance with the moving operation.

4. The information display apparatus according to claim 3, wherein the control unit reduces the display area of each of the second contents at a different timing.

5. The information display apparatus according to claim 1, wherein
the display unit arranges the second content in an invisible state in the screen, and
when the moving operation is performed while the second content is in the invisible state, the control unit expands the display area of the second content in the direction in which the moving operation is performed without moving the second content, to thereby expand the area in which the first content is displayed.

6. The information display apparatus according to claim 5, wherein when a moving operation of moving the first content in a screen upward direction while the second content is in the invisible state, the control unit moves an upper end of the display area of the second content in the screen upward direction.

7. The information display apparatus according to claim 5, wherein
the display unit arranges a third content with the same display size as the second content at the same position as the second content and in an invisible state, and
the control unit reduces the display area of the second content in the direction in which the moving operation is performed, and simultaneously expands a display area of the third content in the direction in which the moving operation is performed, without moving the third content.

8. The information display apparatus according to claim 7, wherein when the moving operation is performed while the entire second content is displayed, the control unit reduces the display area of the second content in the direction in which the moving operation is performed, and simultaneously expands the display area of the third content in the direction in which the moving operation is performed, without moving the third content.

9. The information display apparatus according to claim 8, wherein when the moving operation is performed while the entire third content is displayed, the control unit reduces the display area of the third content in the direction in which the moving operation is performed, to thereby expand the area in which the first content is displayed.

10. A distribution apparatus comprising:
a distribution unit that distributes control information to a terminal device that displays a first content and a second content different from the first content, wherein
the control information causes the terminal device to
display the first content and the second content, and
reduce, when a moving operation is performed on the first content, a display area of the second content without moving the second content, to thereby expand an area in which the first content is displayed.

11. An information display method implemented by an information display apparatus, comprising:
displaying a first content and a second content different from the first content; and
reducing, when a moving operation is performed on the first content, a display area of the second content in a direction in which the moving operation is performed, without moving the second content, to thereby expand an area in which the first content is displayed.

12. A non-transitory computer readable storage medium having stored therein an information display program causing a computer to execute a process comprising:
displaying a first content and a second content different from the first content; and
reducing, when a moving operation is performed on the first content, a display area of the second content in a direction in which the moving operation is performed, without moving the second content, to thereby expand an area in which the first content is displayed.
